(19) United States
(12) Patent Application Publication
(10) Pub. No.: US 2024/0223254 A1
(43) Pub. Date: Jul. 4, 2024

(54) CSI REPORTING WITH SUBSET OF COEFFICIENT INDICATORS

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/555,225

(22) PCT Filed: Apr. 13, 2022
(86) PCT No.: PCT/IB2022/053450

§ 371 Date: Oct. 12, 2023

Related U.S. Application Data
(60) Provisional application No. 63/173,996, filed on Apr. 12, 2021.

(51) Int. Cl. H04B 7/06

(52) U.S. Cl. CPC H04B 7/0626; H04B 7/0639

(57) ABSTRACT

Apparatuses, methods, and systems are disclosed for parameter feedback for reciprocity-based Type-II codebook. One method (800) includes receiving (805), from a RAN, a codebook configuration corresponding to a port-selection codebook and receiving (810) a set of CSI reference signals. The method (800) includes identifying (815) a set of ports based on the CSI reference signals and generating (820) a set of coefficient indicators corresponding to the identified set of ports, where the port-selection codebook comprises a first bitmap that identifies a subset of the coefficient indicators assigned a non-zero amplitude value. The method (800) includes generating (825) a CSI report based the set of CSI reference signals and transmitting (830) the CSI report to the RAN, where the first bitmap is selectively included in the CSI report based on a size of the subset of coefficient indicators.

### CROSS-REFERENCE TO RELATED APPLICATIONS

This application claims priority to U.S. Provisional Patent Application No. 63/173,996 entitled “PARAMETER FEEDBACK FOR RECIPROCITY-BASED TYPE-II CODEBOOK” and filed on Apr. 12, 2021 for Ahmed Hindy and Vijay Nangia, which application is incorporated herein by reference.

### FIELD

The subject matter disclosed herein relates generally to wireless communications and more particularly relates to parameter feedback for reciprocity-based Type-II codebook used in Channel State Information (“CSI”) reporting.

### BACKGROUND

For Channel State Information (“CSI”) reporting in Third Generation Partnership Project (“3GPP”) New Radio (“NR”) Release 16 specification (“Rel-16”), two types of codebooks are defined. The NR Type-I codebook uses multiple predefined matrices from which a selection is made by User Equipment (“UE”) report and/or Radio Resource Control (“RRC”) Configuration. However, the Type-II codebook is not based on a predefined table, but it is based on a specifically designed mathematical formula with a several parameters. The parameters in the formula are determined by RRC Configuration and/or UE report. The NR Type-II codebook is based on a more detailed CSI report and supports Multi-User Multiple-Input, Multiple-Output (“MU-MIMO”) communication.

For the NR Rel-16 Type-II codebook, the number of Precoding Matrix Indicator (“PMI”) bits fed back from the UE to the next-generation node-B (“gNB”) via Uplink Control Information (“UCI”) can be very large (>1000 bits at large bandwidth). In addition, the number of Channel State Information Reference Signals (“CSI-RS”) ports sent in the downlink channel to enable channel estimation at the user equipment can be large as well, leading to higher system complexity and loss of resources over reference signaling.

### BRIEF SUMMARY

Disclosed are procedures for parameter feedback for reciprocity-based Type-II codebook. Said procedures may be implemented by apparatus, systems, methods, or computer program products.

One method at a User Equipment (“UE”) includes receiving, from a Radio Access Network (“RAN”), a codebook configuration corresponding to a port-selection codebook and receiving a set of Channel State Information (“CSI”) reference signals. The method includes identifying a set of ports based on the set of CSI reference signals and generating a set of coefficient indicators corresponding to the identified set of ports, where a subset of the coefficient indicators is assigned a non-zero amplitude value, and where the port-selection codebook comprises a first bitmap that identifies the subset of the coefficient indicators having the non-zero amplitude value.

The method includes generating a CSI report based the set of CSI reference signals and transmitting the CSI report to the RAN, where the CSI report comprises codebook parameters for one or more layers and further contains an indication of a size of the subset of the coefficient indicators, where the first bitmap is selectively included in the CSI report based on a size of the subset of the coefficient indicators having the non-zero amplitude value.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for reciprocity-based type-II codebook:

FIG. 2 is a block diagram illustrating one embodiment of a procedure for parameter feedback for reciprocity-based Type-II codebook:

FIG. 3 is a diagram illustrating one embodiment of Abstract Syntax Notation 1 (“ASN.1”) code for configuring the UE with a reciprocity-based type-II codebook:

FIG. 4 is a diagram illustrating a second embodiment of ASN.1 code for configuring the UE with a reciprocity-based type-II codebook:

FIG. 5 is a diagram illustrating a third embodiment of ASN.1 code for configuring the UE with a reciprocity-based type-II codebook:

FIG. 6 is a block diagram illustrating one embodiment of a user equipment apparatus that may be used for codebook structure for reciprocity-based type-II codebook:

FIG. 7 is a block diagram illustrating one embodiment of a network apparatus that may be used for codebook structure for reciprocity-based type-II codebook: and

FIG. 8 is a flowchart diagram illustrating one embodiment of a method for codebook structure for reciprocity-based type-II codebook.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for codebook structure for reciprocity-based type-II codebook. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For the 3GPP NR Rel-16 Type-II codebook, the number of Precoding Matrix Indicator (“PMI”) bits fed back from the User Equipment (“UE”) in the next-generation node-B (“gNB”) via Uplink Control Information (“UCI”) can be very large (>1000 bits at large bandwidth). In addition, the number of Channel State Information Reference Signals (“CSI-RS”) ports sent in the downlink channel to enable channel estimation at the user equipment can be large as well, leading to higher system complexity and loss of resources over reference signaling. Thereby, further reduction of the PMI feedback bits and/or a reduction in the number of CSI-RS ports utilized is needed to improve efficiency.

A special case of the NR Rel-16 Type-II codebook (dubbed port-selection codebook) was proposed, in which the number of CSI-RS ports was reduced via applying an underlying spatial beamforming process. No insight onto how to design this beamforming process was provided. In addition, it has been recently discussed in the literature that the channel correlation between uplink and downlink channels can be exploited to reduce CSI feedback overhead, even in the Frequency-Division Duplexing (“FDD”) mode where the Uplink (“UL”)-Downlink (“DL”) carrier frequency spacing is not too large. Also, two issues are expected to arise under DL channel estimation based on partial UL channel reciprocity under FDD mode. First, the UL channel estimated at the gNB may not be accurate due to conventional channel estimation issues that are well-known in the field of wireless communications, e.g., channel quantization and hardware impairments. Second, the channel may vary within the time between the transmission of the Sounding Reference Signals (“SRS”) for UL CSI acquisition and the transmission of the beamformed CSI-RSs.

Disclosed herein are efficient CSI report structures for a given codebook, e.g., Type-II port-selection codebook, so as to minimize the CSI feedback overhead. More specifically, methods of reporting CSI feedback parameters related to Frequency Domain (“FD”) basis selection and bitmap indication are discussed.

Regarding the 3GPP NR Rel-15 Type-II Codebook, it is assumed that the gNB is equipped with a two-dimensional (“2D”) antenna array with N₁, N₂ antenna ports per polarization placed horizontally and vertically and communication occurs over N, PMI sub-bands. A PMI subband consists of a set of resource blocks, each resource block consisting of a set of subcarriers. In such case, 2N₁N₂ CSI-RS ports are utilized to enable DL channel estimation with high resolution for NR Rel-15 Type-II codebook.

In order to reduce the UL feedback overhead, a Discrete Fourier transform (“DFT”)-based CSI compression of the spatial domain is applied to L dimensions per polarization, where L<N₁N₂. In the sequel the indices of the 2L dimensions are referred as the Spatial Domain (“SD”) basis indices. The magnitude and phase values of the linear combination coefficients for each sub-band are fed back to the gNB as part of the CSI report. The 2N₁N₂×N₃ codebook per layer takes on the form

W=W₁W₂

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ]$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1$$

where the superscript T denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W₂ are independent for different layers.

In more detail, the specification for the NR Rel. 15 Type-II Codebook is as follows (refer to 3GPP NR Technical Specification (“TS”) 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebook Type set to ‘typeII’
The values of N₁ and N₂ are configured with the higher layer parameter n1-n2-codebookSubsetRestriction. The supported configurations of (N1, N2) for a given number of CSI-RS ports and the corresponding values of (O₁, O₂) are given in Table 5.2.2.2.1-2. The number of CSI-RS ports, P_{CSI-RS}, is 2N₁N₂.
The value of L is configured with the higher layer parameter numberOfBeams, where L=2 when P_{CSI-RS}=4 and L∈{2,3,4} when P_{CSI-RS}>4.
The value of N_{PSK} is configured with the higher layer parameter phaseAlphabetSize, where N_{PSK}∈{4,8}.
The UE is configured with the higher layer parameter subbandAmplitude set to ‘true’ or ‘false’.
The UE shall not report RI>2.

When v=2, where v is the associated RI value, each PMI value corresponds to the codebook indices i₁ and i₂ where

$${i}_{1} = \{ \begin{matrix}[ \begin{matrix}{i}_{1 , 1} & {i}_{1 , 2} & {i}_{1 , 3 , 1} & {i}_{1 , 4 , 1} ]\end{matrix} & v = 1 \\ [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2} ]\end{matrix} & v = 2\end{matrix}$$

$${i}_{2} = \{ \begin{matrix}[ {i}_{2 , 1 , 1} ] & subbandAmplitude = ‘ false ’ , v = 1 \\ [ \begin{matrix}{i}_{2 , 1 , 1} & {i}_{2 , 1 , 2} ]\end{matrix} & subbandAmplitude = ‘ false ’ , v = 2 \\ [ \begin{matrix}{i}_{2 , 1 , 1} & {i}_{2 , 2 , 1} ]\end{matrix} & subbandAmplitude = ‘ true ’ , v = 1 \\ [ \begin{matrix}{i}_{2 , 1 , 1} & {i}_{2 , 2 , 1} & {i}_{2 , 1 , 2} & {i}_{2 , 2 , 2} ]\end{matrix} & subbandAmplitude = ‘ true ’ , v = 2\end{matrix} .$$

The L vectors combined by the codebook are identified by the indices i_{1,1} and i_{1,2}, where

$${i}_{1 , 1} = [ \begin{matrix}{q}_{1} & {q}_{2} ]\end{matrix}$$

$${q}_{1} ∈ \{ 0 , 1 , … , {O}_{1} - 1 \}$$

$${q}_{2} ∈ \{ 0 , 1 , … , {O}_{2} - 1 \}$$

$${i}_{1 , 2} ∈ \{ 0 , 1 , ... , ( \begin{matrix}{N}_{1} {N}_{2} \\ L\end{matrix} ) - 1 \} .$$

Let

$${n}_{1} = [ {n}_{1}^{( 0 )} , … , {n}_{1}^{( L - 1 )} ]$$

$${n}_{2} = [ {n}_{2}^{( 0 )} , … , {n}_{2}^{( L - 1 )} ]$$

$${n}_{1}^{( i )} ∈ \{ 0 , 1 , … , {N}_{1} - 1 \}$$

$${n}_{2}^{( i )} ∈ \{ 0 , 1 , … , {N}_{2} - 1 \}$$

$$and$$

$$C ( x , y ) = \{ \begin{matrix}( \begin{matrix}x \\ y\end{matrix} ) & x \geq y \\ 0 & x < y\end{matrix} .$$

where the values of C(x,y) are given in Table 1 (reproduced below).

Then the elements of n₁ and n₂ are found from i_{1,2} using the algorithm:

$${s}_{- 1} = 0$$

$$for i = 0 , ... . , L - 1$$

Find the largest x*∈{L−1−i, . . . , N₁N₂−1−i} in Table 1 such that:

$${i}_{1 , 2} - {s}_{i} - 1 \geq C ( {x}^{*} , L - i )$$

$${e}_{i} = C ( {x}^{*} , L - i )$$

$${s}_{i} = {s}_{i - 1} + {e}_{i}$$

$${n}^{( i )} = {N}_{1} {N}_{2} - 1 - {x}^{*}$$

$${n}_{1}^{( i )} = {n}^{( i )} mod {N}_{1}$$

$${n}_{2}^{( i )} = \frac{( {n}^{( i )} - {n}_{1}^{( i )} )}{{N}_{1}}$$

When n₁ and n₂ are known, i_{1,2,} is found using:

$${n}_{( i )} = {N}_{1} {n}_{2}^{( i )} + {n}_{1}^{( i )}$$

where the indices i=0,1, . . . , L−1 are assigned such that n⁽ⁱ⁾ increases as i increases

$${i}_{1 , 2} = {\sum }_{i = 0}^{L - 1} C ( {N}_{1} {N}_{2} - 1 - {n}^{( i )} , L - i )$$

where C(x,y) is given in Table 1.

If N₂=1, q₂=0 and n2(i)=0 for i=0,1, . . . , L−1, and q₂ is not reported.
When (N₁, N₂)=(2,1), n₁=[0,1] and n₂=[0,0], and i_{1,2} is not reported.
When (N₁, N₂)=(4,1) and L=4, n₁=[0,1,2,3] and n₂=[0,0,0,0], and i_{1,2} is not reported.
When (N₁, N₂)=(2,2) and L=4, n₁=[0,1,0,1] and n₂=[0,0,1,1], and i_{1,2} is not reported.

TABLE 1
Combinatorial coefficients C(x, y)

y

| x | 1 | 2 | 3 | 4 |
|---|---|---|---|---|
| 0 | 0 | 0 | 0 | 0 |
| 1 | 1 | 0 | 0 | 0 |
| 2 | 2 | 1 | 0 | 0 |
| 3 | 3 | 3 | 1 | 0 |
| 4 | 4 | 6 | 4 | 1 |
| 5 | 5 | 10 | 10 | 5 |
| 6 | 6 | 15 | 20 | 15 |
| 7 | 7 | 21 | 35 | 35 |
| 8 | 8 | 28 | 56 | 70 |
| 9 | 9 | 36 | 84 | 126 |
| 10 | 10 | 45 | 120 | 210 |
| 11 | 11 | 55 | 165 | 330 |
| 12 | 12 | 66 | 220 | 495 |
| 13 | 13 | 78 | 286 | 715 |
| 14 | 14 | 91 | 364 | 1001 |
| 15 | 15 | 105 | 455 | 1365 |

The strongest coefficient on layer i=1, . . . , v is identified by i_{1,3,l}∈{0,1, . . . ,2L−1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l , i}^{( 2 )} ∈ \{ 0 , 1 \}$$

for l=1, . . . , v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ]$$

$${p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

TABLE 2
Mapping of elements of i1,4,1: k_{l,i}⁽¹⁾ to p_{l,i}⁽¹⁾

| k_{l,i}⁽¹⁾ | p_{l,i}⁽¹⁾ |
|---|---|
| 0 | 0 |
| 1 | $\sqrt{\frac{1}{64}}$ |
| 2 | $\sqrt{\frac{1}{32}}$ |
| 3 | $\sqrt{\frac{1}{16}}$ |
| 4 | $\sqrt{\frac{1}{8}}$ |
| 5 | $\sqrt{\frac{1}{4}}$ |
| 6 | $\sqrt{\frac{1}{2}}$ |
| 7 | 1 |

TABLE 3
Mapping of elements of i2,2,1: k_{l,i}⁽²⁾ to p_{l,i}⁽²⁾

| k_{l,i}⁽²⁾ | p_{l,i}⁽²⁾ |
|---|---|
| 0 | $\sqrt{\frac{1}{2}}$ |
| 1 | 1 |

The phase coefficient indicators are

$${i}_{2 , 1 , l} = [ {c}_{l , 0} , {c}_{l , 1} , ... , {c}_{l , 2 L - 1} ]$$

for l=1, . . . , v.

The amplitude and phase coefficient indicators are reported as follows:
The indicators k_{l,i}_{_{1,3,l}}⁽¹⁾=7, k_{l,i}_{_{1,}} and c_{l,i}_{_{1,3,l}}=0 (1=1, . . , v). k_{l,i}_{_{1,3,l}}⁽¹⁾, k_{l,i}_{_{1,3,l}}⁽²⁾, and c_{l,i}_{_{1,3,l}} are not reported for I=1, . . . , v.
The remaining 2L−1 elements of I_{1,4,l} (l=1, . . . , v) are reported, where k_{l,i}⁽¹⁾∈{0,1, . . . ,7}. Let Mᵢ (I=1, . . . , v) be the number of elements of i_{i,4,l} that satisfy k_{l,i}⁽¹⁾>0.

The remaining 2L−1 elements of i_{2,1,l} and i_{2,2,l} (l=1, . . . , v) are reported as follows:
When subbandAmplitude is set to ‘false’,
   k_{l,i}⁽²⁾=1 for l=1, . . . , v, and i=0,1, . . . ,2L−1. i_{2,2,l} is not reported for l=1, . . . , v.
   For l=1, , . . . , v, the elements of i_{2,1,l} corresponding to the coefficients that satisfy k_{l,i}⁽¹⁾>0, i≠i_{1,3,l}, as determined by the reported elements of i_{1,4,l}, are reported, where c_{l,i}∈{0,1, . . . , N_{PSK}−1} and the remaining 2L−M₁ elements of i_{2,1,l} are not reported and are set to c_{l,i}=0.
When subbandAmplitude is set to ‘true’,
   For l=1, . . . , v, the elements of i_{2,2,l} and i_{2,1,l} corresponding to the min(M₁, K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0,1, . . . , N_{PSK}−1}. The values of K⁽²⁾ are given in Table 4. The remaining 2L−min(M₁, K⁽²⁾ elements of i_{2,2,l} are not reported and are set to k_{l,i}⁽²⁾=1. The elements of i_{2,1,l} corresponding to the M₁−min(M₁, K⁽²⁾) weakest non-zero coefficients are reported, where c_{l,i}∈{0,1,2,3}. The remaining 2L−M₁ elements of i_{2,1,l} are not reported and are set to c_{l,i}=0.
When two elements, k_{l,x}⁽¹⁾ and k_{l,y}⁾¹⁾, of the reported elements of i_{1,4,l} are identical (k_{l,x}⁽¹⁾=k_{l,y}⁽¹⁾), then element min(x,y) is prioritized to be included in the set of the min(M₁, K⁽²⁾)−1 strongest coefficients for i_{2,1,l} and i_{2,2,l} (l=1, . . . , v) reporting.

TABLE 4
Full resolution subband coefficients
when subbandAmplitude is set to ‘true’

| L | K⁽²⁾ |
|---|---|
| 2 | 4 |
| 3 | 4 |
| 4 | 6 |

The codebooks for 1-2 layers are given in Table 5, where the indices m₁⁽ⁱ⁾ and m₂⁽ⁱ⁾ are given by

m₁⁽ⁱ⁾=O₁n₁⁽ⁱ⁾+q₁

m₂⁽ⁱ⁾=O₂n₂⁽ⁱ⁾+q₂

For i=0,1, . . . , L−1, and the quantities φ_{l,i}, uₘ, and v_{l,m} are given by

$${φ}_{l , i} = \{ \begin{matrix}{e}^{j 2 π {c}_{l , i} / {N}_{PSK}} & subbandAmplitude = ‘ false ’ \\ {e}^{j 2 π {c}_{l , i} / {N}_{PSK}} & subbandAmplitude = ‘ true ’ , min ( {M}_{l} , {K}^{( 2 )} ) \\ & strongest coefficients ( including {i}_{1 , 3 , l} ) with {k}_{l , i}^{( 1 )} > 0 \\ {e}^{j 2 π {c}_{l , i} / 4} & subbandAmplitude = ‘ true ’ , {M}_{l} - \\ & min ( {M}_{l} , {K}^{( 2 )} ) weakest coefficients with {k}_{l , i}^{( 1 )} > 0 \\ 1 & subbandAmplitude = ‘ true ’ , 2 L - \\ & {M}_{l} coefficients with {k}_{l , i}^{( 1 )} = 0\end{matrix}$$

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} .$$

TABLE 5
Codebook for 1-layer and 2-layer CSI reporting
using antenna ports 3000 to 2999+PCSI-RS

| Layers | |
|---|---|
| υ = 1 | W_{q}_{₁}_{,q}_{₂}_{,n}_{₁}_{,n}_{₂}_{,p}_{₁}_{⁽¹⁾},ₚ_{₁}_{⁽²⁾},ᵢ_{_{2,1,1}}⁽¹⁾ = W_{q}_{₁}_{,q}_{₂}_{,n}_{₁}_{,n}_{₂}_{,p}_{₁}_{⁽¹⁾}_{,p}_{₁}_{⁽²⁾}_{,i}_{_{2,1,1}}_{¹} |
| υ = 2 | ${W}_{{q}_{1} , {q}_{2} , {n}_{1} , {n}_{2} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{q}_{1} , {q}_{2} , {n}_{1} , {n}_{2} , {p}_{1}^{( 1 )} , {p}_{1}^{( 2 )} , {i}_{2 , 1 , 1}}^{1} & {W}_{{q}_{1} , {q}_{2} , {n}_{1} , {n}_{2} , {p}_{2}^{( 1 )} , {p}_{2}^{( 2 )} , {i}_{2 , 1 , 2}}^{2}\end{matrix} ]$ |

$where {W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2 ,$
and the mappings from i1 to q1, q2, n1, n2, p1(1), and p2(1), and from
i2 to i2, 1, 1, i2, 1, 2, p1(2) and p2(2) are as described above, including
the ranges of the constituent indices of i1 and i2.

When the UE is configured with higher layer parameter codebookType set to ‘typeII’, the bitmap parameter typeII-RI-Restriction forms the bit sequence r₁, r₀ where r₀ is the LSB and r₁ is the MSB. When rᵢ is zero, i∈{0,1}, PMI and RI reporting are not allowed to correspond to any precoder associated with v=i+1 layers. The bitmap parameter n1-n2-codebookSubsetRestriction forms the bit sequence B=B₁B₂ where bit sequences B₁, and B₂ are concatenated to form B. To define B₁ and B₂, first define the O₁O₂ vector groups G(r₁,r₂) as

$$G ( {r}_{1} , {r}_{2} ) = \text{} \{ {v}_{{N}_{1} {r}_{1} + {x}_{1} , {N}_{2} {r}_{2} + {x}_{2}} : {x}_{1} = 0 , \\ 1 , ... , {N}_{1} - 1 ; {x}_{2} = 0 , 1 , ... , {N}_{2} - 1 \}$$

$$for$$

$${r}_{1} ∈ \{ 0 , 1 , ... , {O}_{1} - 1 \}$$

$${r}_{2} ∈ \{ 0 , 1 , ... , {O}_{2} - 1 \}$$

The UE shall be configured with restrictions for 4 vector groups indicated by (r₁^{(k)}, r₂^{(k)} for k=0,1,2,3 and identified by the group indices

$${g}^{( k )} = {O}_{1} {r}_{2}^{( k )} + {r}_{1}^{( k )}$$

For k=0,1, . . . ,3, where the indices are assigned such that g^{(k)} increases as k increases. The remaining vector groups are not restricted.
If N₂=1, g^{(k)}=k for k=0,1, . . . ,3, and B₁ is empty.
If N₂>1, B₁=b₁⁽¹⁰⁾ . . . b₁⁽⁰⁾ is the binary representation of the integer β₁ where b₁⁽¹⁰⁾ is the MSB and b₁⁽⁰⁾ is the LSB. β₁ is found using:

$${β}_{1} = {\sum }_{k = 0}^{3} C ( {O}_{1} {O}_{2} - 1 - {g}^{( k )} , 4 - k ) ,$$

where C(x,y) is defined in Table 1.

The group indices g(k) and indicators (r₁^{(k)}, r₂^{(k)}) for k=0,1,2,3 may be found from β₁ using the algorithm:

$${s}_{- 1} = 0$$

$$for$$

$$k = 0 , … , 3$$

Find the largest x*∈{3−k, . . . , 0₁O₂−1−k} such that

$${β}_{1} - {s}_{k - 1} \geq C ( {x}^{*} , 4 - k )$$

$${e}_{k} = C ( {x}^{*} , 4 - k )$$

$${s}_{k} = {s}_{k - 1} + {e}_{k}$$

$${g}^{( k )} = {O}_{1} {O}_{2} - 1 - {x}^{*}$$

$${r}_{1}^{( k )} = {g}^{( k )} mod {O}_{1}$$

$${r}_{2}^{( k )} = \frac{( {g}^{( k )} - {r}_{1}^{( k )} )}{{o}_{1}}$$

The bit sequence B₂=B₂⁽⁰⁾B₂⁽¹⁾B₂⁽²⁾B₂⁽³⁾ is the concatenation of the bit sequences B₂^{(k)} for k=0,1, . . . ,3, corresponding to the group indices g^{(k)}. The bit sequence B₂^{(k)} is defined as

$${B}_{2}^{( k )} = {b}_{2}^{( k , 2 {N}_{1} {N}_{2} - 1 )} … {b}_{2}^{( k , 0 )}$$

Bits b₂^{k,2(N}^{₁}^{x}^{₂}^{+x}^{₁}⁾⁺¹⁾b₂^{(k,2(N}^{₁}^{N}^{₂}^{+x}^{₁})) indicate the maximum allowed amplitude coefficient p_{l,i}⁽¹⁾ for the vector in group g^{(k)} indexed by x₁,x₂, where the maximum amplitude coefficients are given in Table 6. A UE that does not report parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 6
Maximum allowed amplitude coefficients for restricted vectors

| Bits b₂^{(k,2(N}₁^{x}₂^{+x}₁⁾⁺¹⁾b₂^{(k,2(N}₁^{x}₂^{+x}₁⁾⁾ | Maximum Amplitude Coefficient p_{l,i}⁽¹⁾ |
|---|---|
| 00 | 0 |
| 01 | $\sqrt{\frac{1}{4}}$ |
| 10 | $\sqrt{\frac{1}{2}}$ |
| 11 | 1 |

Regarding 3GPP NR Rel-15, for Type-II Port Selection codebook, only K (where K≤ 2N₁N₂) beamformed CSI-RS ports are utilized in DL transmission, in order to reduce complexity. The K×N₃ codebook matrix per layer takes on the form:

$$W = {W}_{1}^{P S} {W}_{2}$$

Here, W₂ follows the same structure as the conventional NR Rel-15 Type-II Codebook, and are layer specific. W₁^{PS} is a K×2L block-diagonal matrix with two identical diagonal blocks, i.e.,

$${W}_{1}^{P S} = [ \begin{matrix}E & 0 \\ 0 & E\end{matrix} ] ,$$

and E is an K/2×L matrix whose columns are standard unit vectors, as follows:

$$E = [ \begin{matrix}{e}_{mod ( {m}_{P S} {d}_{P S} , K / 2 )}^{( K / 2 )} & {e}_{mod ( {m}_{P S} {d}_{P S} + 1 , K / 2 )}^{( K / 2 )} & … & {e}_{mod ( {m}_{P S} {d}_{P S} + L - 1 , K / 2 )}^{( K / 2 )}\end{matrix} ] ,$$

where eᵢ^{(k)} is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] ,$$

$$[ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] ,$$

$$[ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, mps parametrizes the location of the first 1 in the first column of E, whereas d_{PS} represents the row shift corresponding to different values of m_{PS}.

In more detail, the specification for the NR Rel. 15 Type-II Port Selection Codebook is as follows (see 3GPP NR TS 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection’
The number of CSI-RS ports is given by P_{CSI-RS}∈{4,8,12,16,24,32} as configured by higher layer parameter nrofPorts.
The value of L is configured with the higher layer parameter numberOfBeams, where L=2 when P_{CSI-RS}=4 and L∈{2,3,4} when P_{CSI-RS}>4.
The value of d is configured with the higher layer parameter portSelectionSamplingSize, where d∈{1,2,3,4} and

$$d \leq min ( \frac{{P}_{CSI - RS}}{2} , L ) .$$

The value of N_{PSK} is configured with the higher layer parameter phase AlphabetSize, where N_{PSK}∈{4,8}.
The UE is configured with the higher layer parameter subbandAmplitude set to ‘true’ or ‘false’.
The UE shall not report RI>2.

The UE is also configured with the higher layer parameter typeII-PortSelectionRI-Restriction. The bitmap parameter typeII-PortSelectionRI-Restriction forms the bit sequence r₁,r₀ where r₀ is the LSB and r₁ is the MSB. When rᵢ is zero, i∈{0,1}, PMI and RI reporting are not allowed to correspond to any precoder associated with v=i+1 layers.

When v≤2, where v is the associated RI value, each PMI value corresponds to the codebook indices i₁ and i₂ where

$${i}_{1} = \{ \begin{matrix}[ \begin{matrix}{i}_{1 , 1} & {i}_{1 , 3 , 1} & {i}_{1 , 4 , 1}\end{matrix} ] & υ = 1 \\ [ \begin{matrix}{i}_{1 , 1} & {i}_{1 , 3 , 1} & {i}_{1 , 4 , 1} & {i}_{1 , 3 , 2} & {i}_{1 , 4 , 2}\end{matrix} ] & υ = 2\end{matrix}$$

$${i}_{2} = \{ \begin{matrix}[ {i}_{2 , 1 , 1} ] & subbandAmplitude = ' false ' , υ = 1 \\ [ \begin{matrix}{i}_{2 , 1 , 1} & {i}_{2 , 1 , 2}\end{matrix} ] & subbandAmplitude = ' false ' , υ = 2 \\ [ \begin{matrix}{i}_{2 , 1 , 1} & {i}_{2 , 2 , 1}\end{matrix} ] & subbandAmplitude = ' true ' , υ = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ' true ' , υ = 2\end{matrix} .$$

The L antenna ports per polarization are selected by the index i_{1,1}, where

$${i}_{1 , 1} ∈ \{ 0 , 1 , … , ⌈ \frac{{P}_{CSI - RS}}{2 d} ⌉ - 1 \} .$$

The strongest coefficient on layer l, l=1, . . . , v is identified by i_{1,3,l}∈{0,1, . . . , 2L−1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ] \\ {i}_{2 , 2 , l} = [ {k}_{l , 0}^{( 2 )} , {k}_{l , 1}^{( 2 )} , … , {k}_{l , 2 L - 1}^{( 2 )} ] \\ {k}_{l , i}^{( 1 )} ∈ \{ 0 , 1 , … , 7 \} \\ {k}_{l , i}^{( 2 )} ∈ \{ 0 , 1 \}$$

for l=1, . . . , v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ] \\ {p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows:
The indicators k_{l,i}_{_{1,3,l}}⁽¹⁾=7, k_{l,i}_{_{1,3,l}}⁽²⁾=1, and c_{l,i}_{_{1,3,l}}=0 (l=1, . . . , v). k_{l,i}_{_{1,3,l}}⁽¹⁾, k_{l,i}_{_{1,3,l}}⁽²⁾, and c_{l,i}_{_{1,3,l}} are not reported for l=1, . . . , v.
The remaining 2L−1 elements of i_{1,4,l} (l=1, . . . , v) are reported, where k_{l,i}⁽¹⁾∈{0,1, . . . ,7}. Let M₁ (l=1, . . . , v) be the number of elements of i_{1,4,l} that satisfy k_{l,i}⁽¹⁾>0.
The remaining 2L−1 elements of i_{2,1,l} and i_{2,2,l} (l=1, . . . , v) are reported as follows:
   When subbandAmplitude is set to ‘false’,
      k_{l,i}⁽²⁾=1 for l=1, . . . , v, and i=0,1, . . . ,2L−1. i_{2,2,l} is not reported for l=1, . . . , v.
      For l=1, . . . , v, the M₁−1 elements of i_{2,1,l} corresponding to the coefficients that satisfy k_{l,i}⁽¹⁾>0, i≠i_{1,3,l}, as determined by the reported elements of i_{1,4,l}, are reported, where c_{l,i}∈{0,1, . . . , N_{PSK}−1} and the remaining 2L−M₁ elements of i_{2,1,l} are not reported and are set to c_{l,i}=0.
   When subbandAmplitude is set to ‘true’,
      For l=1, . . . , v, the elements of i_{2,2,l} and i_{2,1,l} corresponding to the min(M₁,K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0, 1, . . . , N_{PSK}−1}. The values of K⁽²⁾ are given in Table 4. The remaining 2L−min(M₁,K⁽²⁾) elements of i_{2,2,l} are not reported and are set to k_{l,i}⁽²⁾=1. The elements of i_{2,1,l} corresponding to the M₁−min(M₁,K⁽²⁾) weakest non-zero coefficients are reported, where c_{l,i}∈{0,1,2,3}. The remaining 2L−M₁ elements of i_{2,1,l} are not reported and are set to c_{l,i}=0.
When two elements, k_{l,x}⁽¹⁾ and k_{l,y}⁽¹⁾, of the reported elements of i_{1,4,l} are identical (K_{l,x}⁽¹⁾=k_{l,y}⁽¹⁾, then element min(x,y) is prioritized to be included in the set of the min(M₁,K⁽²⁾)−1 strongest coefficients for i_{2,1,l} and i_{2,2,l} (l=1, . . . , v) reporting.

The codebooks for 1-2 layers are given in Table 7, where the quantity φ_{l,i} is given by

$${φ}_{l , i} = \{ \begin{matrix}{e}^{j \frac{2 π {c}_{l , i}}{{N}_{PSK}}} & subbandAmplitude = ‘ false ’ \\ {e}^{j \frac{2 π {c}_{l , i}}{{N}_{PSK}}} & \begin{matrix}subbandAmplitude = ‘ true ’ , min ( {M}_{l} , {K}^{( 2 )} ) \\ strongest coefficients ( including {i}_{1 , 3 , l} ) with {k}_{l , i}^{( 1 )} > 0\end{matrix} \\ {e}^{j \frac{2 π {c}_{l , i}}{4}} & \begin{matrix}subbandAmplitude = ‘ true ’ , {M}_{l} - min ( {M}_{l} , {K}^{( 2 )} ) \\ weakest coefficients with {k}_{l , i}^{( 1 )} > 0\end{matrix} \\ 1 & \begin{matrix}subbandAmplitude = ‘ true ’ , 2 L - {M}_{l} \\ coefficients with {k}_{l , i}^{( 1 )} = 0\end{matrix}\end{matrix}$$

and Vₘ is a P_{CSI-RS}/2-element column vector containing a value of 1 in element (m mod P_{CSI-RS}/2) and zeros elsewhere (where the first element is element 0).

TABLE 7
Codebook for 1-layer and 2-layer CSI reporting
using antenna ports 3000 to 2999+P_{CSI-RS}

| Layers | |
|---|---|
| υ = 1 | Wᵢ_{_{1,1}}_{,p}_{₁}_{⁽¹⁾}_{,p}_{₁}_{⁽²⁾}_{,i}_{_{2,1,1}}⁽¹⁾ = Wᵢ_{_{1,1}}_{,p}_{₁}_{⁽¹⁾}_{,p}_{₁}_{⁽²⁾}_{,i}_{_{2,1,1}}¹ |
| υ = 2 | ${W}_{{i}_{1 , 1} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{i}_{1 , 1} , {p}_{1}^{( 1 )} , {p}_{1}^{( 2 )} , {i}_{2 , 1 , 1}}^{1} & {W}_{{i}_{1 , 1} , {p}_{2}^{( 1 )} {p}_{2}^{( 2 )} , {i}_{2 , 1 , 2}}^{2}\end{matrix} ]$ |

$where {W}_{{i}_{1 , 1} , {p}_{l}^{( 1 )} , {p}_{l}^{( 2 )} , {i}_{2 , 1 , l}}^{l} = \frac{1}{\sqrt{{\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{i}_{1 , 1} a + i} {p}_{l , i}^{( 1 )} {p}_{l , i}^{( 2 )} {φ}_{l , i} \\ {\sum }_{i = 0}^{L - 1} {v}_{{i}_{1 , 1} d + i} {p}_{l , i + L}^{( 1 )} {p}_{l , i + L}^{( 2 )} {φ}_{l , i + L}\end{matrix} ] , l = 1 , 2 ,$
and the mappings from i₁ to i_{1,1}, p₁⁽¹⁾, and p₂⁽¹⁾ and from i₂ to
1_{2,1,1}, 1_{2,1,2}, p₁⁽²⁾, and p₂⁽²⁾ are as described above,
including the ranges of the constituent indices of i₁ and i₂.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for RI=1,2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁ . . . =ϕ, i.e., wideband reporting. For RI>2, different beams are used for each pair of layers. The NR Rel-15 Type-I codebook may be depicted as a low-resolution version of NR Rel-15 Type-II codebook with spatial beam selection per layer-pair and phase combining only.

Regarding the 3GPP NR Rel-16 Type-II Codebook, it is assumed that the gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel-16 Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$$W = {W}_{1} {\tilde{W}}_{2} {W}_{f}^{H}$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{\frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} - 1$$

where the superscript T denotes a matrix transposition operation. Note that O₁, O₂ oversampling factors are assumed for the 2D DFT matrix from which matrix B is drawn. Note that W₁ is common across all layers. In various embodiments, the above parameters comply with 3GPP TS 38.214 definitions and procedures.

W_{f} is an N₃×M matrix (where M<N₃) with columns selected from a critically-sampled size-N; DFT matrix, as follows:

$${w}_{f} = [ \begin{matrix}{f}_{{k}_{0}} & {f}_{{k}_{1}} & … & {f}_{{k}_{M ′ - 1}}\end{matrix} ] , 0 \leq {k}_{i} < {N}_{3} - 1 \\ {f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T}$$

Only the indices of the L selected columns of B are reported, along with the oversampling index taking on O₁O₂ values. Similarly, for W_{f}, only the indices of the M selected columns out of the predefined size-N₃ DFT matrix are reported. In the sequel the indices of the M dimensions are referred as the selected Frequency Domain (“FD”) basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, W_{f} are selected independent for different layers.

Magnitude and phase values of an approximately β fraction of the 2LM available coefficients are reported to the gNB (β<1) as part of the CSI report. Note that coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N_{2×}N₃−1 coefficients' information.

In more detail, the specification for the NR Rel. 16 Type-II Codebook is as follows (see 3GPP NR TS 38.214):

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’
The values of N₁ and N₂ are configured with the higher layer parameter n₁-n₂-codebookSubsetRestriction-r16. The supported configurations of (N₁, N₂) for a given number of CSI-RS ports and the corresponding values of (O₁, O₂) are given in Table 5.2.2.2.1-2. The number of CSI-RS ports, P_{CSI-RS}, is 2N₁N₂.
The values of L, β and pᵥ are determined by the higher layer parameter paramCombination-r16, where the mapping is given in Table 8.
The UE is not expected to be configured with paramCombination-r16 equal to
   3, 4, 5, 6, 7, or 8 when P_{CSI-RS}=4,
   7 or 8 when P_{CSI-RS}<32
   7 or 8 when higher layer parameter typeII-RI-Restriction-r16 is configured with rᵢ=1 for any i>1.
   7 or 8 when R=2.

The parameter R is configured with the higher-layer parameter numberOfPMISubbandsPerCQISubband-r16. This parameter controls the total number of precoding matrices N₃ indicated by the PMI as a function of the number of configured subbands in csi-ReportingBand, the subband size configured by the higher-level parameter subbandSize and of the total number of PRBs in the bandwidth part according to Table 5.2.1.4-2, as follows:
When R=1:
   One precoding matrix is indicated by the PMI for each subband in csi-ReportingBand.
When R=2:
   For each subband in csi-ReportingBand that is not the first or last subband of a BWP, two precoding matrices are indicated by the PMI: the first precoding matrix corresponds to the first N_{PRB}^{SB}/2 PRBs of the subband and the second precoding matrix corresponds to the last N_{PRB}^{SB}/2 PRBs of the subband.
   For each subband in csi-ReportingBand that is the first or last subband of a BWP
   If one precoding

$$( {N}_{BWP , i}^{start} mod {N}_{PRB}^{SB} ) \geq \frac{{N}_{PRB}^{SB}}{2} ,$$

one precoding matrix is indicated by the PMI corresponding to the first subband. If

$$( {N}_{BWP , i}^{start} mod {N}_{PRB}^{SB} ) < \frac{{N}_{PRB}^{SB}}{2} ,$$

two precoding matrices are indicated by the PMI corresponding to the first subband: the first precoding matrix corresponds to the first

$$\frac{{N}_{PRB}^{SB}}{2} - ( {N}_{BWP , i}^{start} mod {N}_{PRB}^{SB} ) PRBs$$

of the first subband and the second precoding matrix corresponds to the last N_{PRB}^{SB}/2 PRBs of the first subband.
If

$$1 + ( {N}_{BWP , i}^{start} + {N}_{BWP , i}^{size} - 1 ) mod {N}_{PRB}^{SB} \leq \frac{{N}_{PRB}^{SB}}{2} ,$$

one precoding matrix is indicated by the PMI corresponding to the last subband. If

$$1 + ( {N}_{BWP , i}^{start} + {N}_{BWP , i}^{size} - 1 ) mod {N}_{PRB}^{SB} > \frac{{N}_{PRB}^{SB}}{2} ,$$

two precoding matrices are indicated by the PMI corresponding to the last subband: the first precoding matrix corresponds to the first N_{PRB}^{SB}/2 PRBs of the last subband and the second precoding matrix corresponds 2 to the last

$$1 + ( {N}_{BWP , i}^{start} + {N}_{BWP , i}^{size} - 1 ) mod {N}_{PRB}^{SB} - \frac{{N}_{PRB}^{SB}}{2} PRBs$$

of the last subband.

TABLE 8
Codebook parameter configurations for L, β and p_{ν}

| | |
|---|---|
| paramCombination- | p_{ν} |

| r16 | L | ν ∈ {1, 2} | ν ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value v according to the configured higher layer parameter typeII-RI-Restriction-r16. The UE shall not report v>4.

The PMI value corresponds to the codebook indices of i₁ and i₂ where

$${i}_{1} = \{ \begin{matrix}[ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1}\end{matrix} ] & v = 1 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2}\end{matrix} ] & v = 2 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3}\end{matrix} ] & v = 3 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3} & {i}_{1 , 6 , 4} & {i}_{1 , 7 , 4} & {i}_{1 , 8 , 4}\end{matrix} ] & v = 4\end{matrix} \\ {i}_{2} = \{ \begin{matrix}[ \begin{matrix}{i}_{2 , 3 , 1} & {i}_{2 , 4 , 1} & {i}_{2 , 5 , 1}\end{matrix} ] & v = 1 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2}\end{matrix} ] & v = 2 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3}\end{matrix} ] & v = 3 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} & {i}_{2 , 3 , 4} & {i}_{2 , 4 , 4} & {i}_{2 , 5 , 4}\end{matrix} ] & v = 4\end{matrix}$$

The precoding matrices indicated by the PMI are determined from L+Mᵥ vectors.

L vectors, vₘ_{₁}_{⁽ⁱ⁾}_{,m}_{₂}_{⁽ⁱ⁾}, i=0,1, . . . , L−1, are identified by the indices q₁, q₂, n₁, n₂, indicated by i_{1,1}, i_{1,2}, obtained as in 5.2.2.2.3, where the values of C(x, y) are given in Table 11.

$${M}_{v} = ⌈ {p}_{v} \frac{{N}_{3}}{R} ⌉$$

vectors, [y_{0,l}^{(f)}, y_{1,l}^{(f)}, . . . , y_{N}_{_{3−1,l}}^{(f)}]^{T}, f=0,1, . . . , Mᵥ−1, are identified by Mᵢₙᵢₜᵢₐₗ (for N₃>19) and n_{3,l} (l=1, . . . , v) where

$${M}_{initial} ∈ \{ - 2 {M}_{v} + 1 , - 2 {M}_{v} + 2 , … , 0 \}$$

$${n}_{3 , l} = [ {n}_{3 , l}^{( 0 )} , … , {n}_{3 , l}^{( {M}_{v} - 1 )} ]$$

$${n}_{3 , l}^{( f )} ∈ \{ 0 , 1 , … , {N}_{3} - 1 \}$$

which are indicated by means of the indices i_{1,5} (for N₃>19) and i_{1,6,l} (for Mᵥ>1 and l=1, . . . , v), where

$${i}_{1 , 5} ∈ \{ 0 , 1 , … , 2 {M}_{v} - 1 \}$$

$${i}_{1 , 6 , l} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix}$$

The amplitude coefficient indicators i_{2,3,l} and i_{2,4,l} are

$${i}_{2 , 3 , l} = [ \begin{matrix}{k}_{l , 0}^{( 1 )} & {k}_{l , 1}^{( 1 )}\end{matrix} ]$$

$${i}_{2 , 4 , l} = [ {k}_{l , 0}^{( 2 )} … {k}_{l , {M}_{v} - 1}^{( 2 )} ]$$

$${k}_{l , f}^{( 2 )} = [ {k}_{l , 0 , f}^{( 2 )} … {k}_{l , 2 L - 1 , f}^{( 2 )} ]$$

$${k}_{l , p}^{( 1 )} ∈ \{ 1 , … , 15 \}$$

$${k}_{l , i , f}^{( 2 )} ∈ \{ 0 , … , 7 \}$$

for l=1, . . . , v.

The phase coefficient indicator i_{2,5,l} is

$${i}_{2 , 5 , l} = [ {c}_{l , 0} … {c}_{l , {M}_{v} - 1} ]$$

$${c}_{l , f} = [ {c}_{l , 0 , f} … {c}_{l , 2 L - 1 , f} ]$$

$${c}_{l , i , f} ∈ \{ 0 , … , 15 \}$$

for l=1, . . . , v.

Let K₀=[β2LM₁]. The bitmap whose nonzero bits identify which coefficients in i_{2,4,l} and i_{2,5,l} are reported, is indicated by i_{1,7,l}

$${i}_{1 , 7 , l} = [ {k}_{l , 0}^{( 3 )} … {k}_{l , {M}_{v} - 1}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} ∈ \{ 0 , 1 \}$$

for l=1, . . . , v, such that kₗ^{NZ}=Σᵢ₌₀^{2L-1}Σ_{f=0}^{M}^{ᵥ}⁻¹l_{l,i,f}⁽³⁾≤K₀ is the number of nonzero coefficients for layer l=1, . . . , v and K^{NZ}=Σᵢ₌₁^{v}Kₗ^{NZ}≤2K₀ is the total number of nonzero coefficients.

The indices of i_{2,4,l}, i_{2,5,l} and i_{1,7,l} are associated to the Mᵥ codebook indices in n_{3,l}.

The mapping from k_{l,p}⁽¹⁾ to the amplitude coefficient p_{l,p}⁽¹⁾ is given in Table 9 and the mapping from k_{l,i,f}⁽²⁾ to the amplitude coefficient p_{l,i,f}⁽²⁾ is given in Table 10. The amplitude coefficients are represented by

$${P}_{l}^{( 1 )} = [ \begin{matrix}{p}_{l , 0}^{( 1 )} & {p}_{l , 1}^{( 1 )} ]\end{matrix}$$

$${p}_{l}^{( 2 )} = [ {p}_{l , 0}^{( 2 )} … {p}_{l , {M}_{v} - 1}^{( 2 )} ]$$

$${p}_{l , f}^{( 2 )} = [ {p}_{l , 0 , f}^{( 2 )} … {p}_{l , 2 L - 1 , f}^{( 2 )} ]$$

for l=1, . . . , v.

Let fₗ*∈{0,1, . . . , Mᵥ−1} be the index of i_{2,4,l} and iₗ*∈{0,1, . . . ,2L−1} be the index of k_{l,f}_{ₗ}_{*}⁽²⁾ which identify the strongest coefficient of layer l, i.e., the element k_{l,i,}_{ₗ}_{*,f}_{ₗ}_{*}⁽²⁾ of i_{2,4,l}, for l=1, . . . , v. The codebook indices of n_{3,l} are remapped with respect to n_{3,l}^{(f}^{ₗ}^{*)} as n_{3,l}^{(f)}=(n_{3,l}^{(f)}−n_{3,l}^{(f}^{ₗ}^{*)}mod N₃, such that n_{3,l}^{(f}^{ₗ}^{*)}=0, after remapping. The index f is remapped with respect to fₗ* as f=(f−fₗ*)mod Mᵥ, such that the index of the strongest coefficient is fₗ*=0 (l=1, . . . , v), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0,1, , . . ,2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & v = 1 \\ {i}_{l}^{*} & 1 < v \leq 4\end{matrix}$$

for l=1, . . . , v.

TABLE 9
Mapping of elements of i_{2,3,l}: k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1$$

and c_{l,i*}_{ₗ}_{,0}=0 (l=1, . . . , v). The indicators

$${k}_{l , ⌊ \frac{{i}_{l}^{*}}{L} ⌋}^{( 1 )} , {k}_{l , {i}_{l}^{*} , 0}^{( 2 )} and {c}_{l , {i}_{l}^{*} , 0}$$

are not reported for l=1, . . . , v.
The indicator

$${k}_{l , ( ⌊ \frac{{{i}_{l}}^{*}}{L} ⌋ + 1 ) mod 2}^{( 1 )}$$

is reported for l=1, . . . , v.
The K^{NZ}−v indicators k_{l.i,f}⁽²⁾ for which k_{l,i,f}⁽³⁾=1, i≠iₗ*, f≠0 are reported.
The K^{NZ}−v indicators c_{l,i,f} for which k_{l,if,}⁽³⁾=1, i≠iₗ*, f≠0 are reported.
The remaining 2L·Mᵥ·v−K^{NZ} indicators k_{l,i,f}⁽²⁾ are not reported.
The remaining 2L·Mᵥ·v−K^{NZ} indicators c_{l,i,f} are not reported.

TABLE 10
Mapping of elements of i_{2,4,1}: k_{l,i,f}⁽²⁾ to p_{l,i,f}⁽²⁾

| k_{l,i,f}⁽²⁾ | p_{l,i,f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in 5.2.2.2.3, where the values of C(x, y) are given in Table 11.

For N₃>19, Mᵢₙᵢₜᵢₐₗ is identified by i_{1,5}.

For all values of N₃, n_{3,l}⁽⁰⁾=0 for l=1, . . . , v. If Mᵥ>1, the nonzero elements of n_{3,l}, identified by n_{3,l}⁽¹⁾, . . . , n_{3,l}^{(M}^{ᵥ}⁻¹⁾, are found from i_{1,6,l} (l=1, . . . , v), for N₃≤19, and from i_{1,6,l} (l=1, . . . , v) and Mᵢₙᵢₜᵢₐₗ, for N₃>19, using C(x, y) as defined in Table 11 and the algorithm:

```
s₀ = 0
for f = 1, ... , M_{ν} − 1
  Find the largest x* ∈ {M_{ν} − 1 − f, ... , N₃ − 1 − f} in Table 11 such
  that
  i_{1,6,l} − s_{f-1} ≥ C(x*, M_{ν} − f)
  e_{f} = C(x*, M_{ν} − f)
  s_{f} = s_{f-1} + e_{f}
  if N₃ ≤ 19
    n_{3,l}^{(f)} = N₃ − 1 − x*
  else
    nₗ^{(f)} = 2M_{ν} − 1 − x*
    if nₗ^{(f)} ≤ Mᵢₙᵢₜᵢₐₗ + 2M_{ν} − 1
      n_{3,l}^{(f)} = nₗ^{(f)}
    else
      n_{3,l}^{(f)} = nₗ^{(f)} + (N₃ − 2M_{ν})
    end if
  end if
```

TABLE 11
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known, i_{1,5} and i_{1,6,l} (l=1, . . . , v) are found as follows:
If N₃≤19, i_{1,5}=0 and is not reported. If Mᵥ=1, i_{1,6,l}=0, for l=1, . . . , v, and is not reported. If Mᵥ>1, i_{1,6,l}=Σ_{f=1}^{M}^{ᵥ}⁻¹C(N₃−1−n_{3,l}^{(f)}, Mᵥ−f), where C(x, y) is given in Table 11 and where the indices f=1, . . . , Mᵥ−1 are assigned such that n_{3,l}^{(f)} increases as f increases.
If N₃>19, Mᵢₙᵢₜᵢₐₗ is indicated by i_{1,5}, which is reported and given by

$${i}_{1 , 5} = \{ \begin{matrix}{M}_{initial} & {M}_{initial} = 0 \\ {M}_{initial} + 2 {M}_{v} & {M}_{initial} < 0\end{matrix}$$

Only the nonzero indices n_{3,l}^{(f)}∈IntS, where IntS={(Mᵢₙᵢₜᵢₐₗ+i)mod N₃, and i=0,1, . . . ,2Mᵥ−1}, are reported, where the indices f=1, . . . , Mᵥ−1 are assigned such that n_{3,l}^{(f)} increases as f increases. Let

$${n}_{l}^{( f )} = \{ \begin{matrix}{n}_{3 , l}^{( f )} & {n}_{3 , l}^{( f )} \leq {M}_{initial} + 2 {M}_{v} - 1 \\ {n}_{3 , l}^{( f )} - ( {N}_{3} - 2 {M}_{v} ) & {n}_{3 , l}^{( f )} > {M}_{initial} + {N}_{3} - 1\end{matrix} ,$$

then i_{1,6,l}=Σ_{f=1}^{M}^{ᵥ}⁻¹C(2Mᵥ−1−nᵢ^{(f)}, Mᵥ−f), where C(x, y) is given in Table 11.

The codebooks for 1-4 layers are given in Table 12, where m₁⁽ⁱ⁾, m₂⁽ⁱ⁾, for i=0,1, . . . , L−1, vₘ_{₁}_{⁽ⁱ⁾}_{,m}_{₂}_{⁽ⁱ⁾} are obtained as in clause 5.2.2.2.3 of 3GPP NR TS 38.214, and the quantities φ_{l,i,f} and y_{t,l} are given by

$${φ}_{l , i , f} = {e}^{j \frac{2 π {c}_{l , i , f}}{16}}$$

$${y}_{t , l} = [ \begin{matrix}{y}_{t , l}^{( 0 )} & {y}_{t , l}^{( 1 )} & … & {y}_{t , l}^{( {M}_{v} - 1 )}\end{matrix} ]$$

where t={0,1, . . . , N₃−1}, is the index associated with the precoding matrix. l={1, . . . , v}, and with

$${y}_{t , l}^{( f )} = {e}^{j \frac{2 π {tn}_{3 , l}^{( f )}}{{N}_{3}}}$$

for f=0,1, . . . , Mᵥ−1.

TABLE 12
Codebook for 1-layer. 2-layer, 3-layer and 4-layer CSI
reporting using antenna ports 3000 to 2999+PCSI-RS

| Layers | |
|---|---|
| υ = 1 | W_{q}_{₁}_{,q}_{₂}_{,n}_{₁}_{,n}_{₂}_{,n}_{_{3,1}}_{,p}_{₁}_{⁽¹⁾},ₚ_{₁}_{⁽²⁾},ᵢ_{_{2,5,1}}_{,t} = W_{q}_{₁}_{,q}_{₂}_{,n}_{₁}_{,n}_{₂}_{,n}_{_{3,1}}_{,p}_{₁}_{⁽¹⁾}_{,p}_{₁}_{⁽²⁾}_{,i}_{_{2,5,1}}_{,t} |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2}\end{matrix} ]$ |
| υ = 3 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \frac{1}{\sqrt{3}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} \\ {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5}}^{3} \text{?} & \end{matrix}$ |
| υ = 4 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \frac{1}{2} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} \\ {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3}}^{3} \text{?} & \end{matrix}$ |

$Where {W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$
and the mappings from i₁ to q₁, q₂, n₁, n₂, n_{3,1}, n_{3,2}, n_{3,3}, n_{3,4}, and from i₂ to i_{2,5,1}, i_{2,5,2},
i_{2,5,3}, i_{2,5,4}, p₁⁽¹⁾, p₂⁽¹⁾, p₃⁽¹⁾ and p₄⁽¹⁾, p₁⁽²⁾, p₂⁽²⁾, p₃⁽²⁾ and p₄⁽²⁾ are as described above, including the
ranges of the constituent indices of i₁ and i₂.

For coefficients with k_{l,i,f}⁽³⁾=0, amplitude and phase are set to zero, i.e., p_{l,i,f}⁽²⁾=0 and φ_{l,i,f}=0.

The bitmap parameter typeII-RI-Restriction-r16 forms the bit sequence r₃, r₂, r₁, r₀ where r₀ is the LSB and r₃ is the MSB. When rᵢ is zero, i∈{0,1, . . . ,3}, PMI and RI reporting are not allowed to correspond to any precoder associated with v=i+1 layers.

The bitmap parameter n1-n2-codebookSubsetRestriction-r16 forms the bit sequence B=B₁B₂ and configures the vector group indices g^{(k)} as in clause 5.2.2.2.3 of 3GPP NR TS 38.214. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0,1, . . . , L−1}, of the coefficients associated with the vector in group g^{(k)} indexed by x₁, x₂, where the maximum amplitudes are given in Table 13 and the average coefficient amplitude is restricted as follows

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

for l=1, . . . , v, and p=0,1. A UE that does not report the parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 13
Maximum allowed average coefficient
amplitudes for restricted vectors

| | Maximum |
|---|---|
| Bit | Average Coefficient |
| b₂^{(k,2(N}^{₁}^{x}^{₂}^{+x}^{₁}⁾⁺¹⁾ b₂^{(k,2(N}^{₁}^{x}^{₂}^{+x}^{₁}⁾⁾ | Amplitude γ_{i+pL} |
| 00 | 0 |
| 01 | \sqrt{¼} |
| 10 | \sqrt{½} |
| 11 | 1 |

Regarding 3GPP NR Rel-16, for Type-II Port Selection codebook, only K (where K≤2N₁N₂) beamformed CSI-RS ports are utilized in DL transmission, in order to reduce complexity. The K×N₃ codebook matrix per layer takes on the form:

W=W₁^{PS}\tilde{W}₂W_{f}^{H}

Here, \tilde{W}₂ and W₃ follow the same structure as the conventional NR Rel-16 Type-II Codebook, where both are layer specific. The matrix W₁^{PS} is a K×2L block-diagonal matrix with the same structure as that in the NR Rel-15 Type-II Port Selection Codebook.

In more detail, the specification for the NR Rel. 16 Type-II Port Selection Codebook is as follows:

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection-r16’
The number of CSI-RS ports is configured as in Clause 5.2.2.2.4 of 3GPP NR TS 38.214
The value of d is configured with the higher layer parameter portSelectionSamplingSize-r16, where d∈{1,2,3,4} and d≤L.
The values L, β and pᵥ are configured as in Clause 5.2.2.2.5 of 3GPP NR TS 38.214, where the supported configurations are given in Table 14.

TABLE 14
Codebook parameter configurations for L, β andp_{ν}

| | |
|---|---|
| paramCombination- | p_{ν} |

| r16 | L | ν ∈ {1, 2} | ν ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The UE shall report the RI value v according to the configured higher layer parameter typeII-PortSelectionRI-Restriction-r16. The UE shall not report v>4.
The values of R is configured as in Clause 5.2.2.2.5 of 3GPP NR TS 38.214.

The UE is also configured with the higher layer bitmap parameter typeII-PortSelectionRI-Restriction-r16, which forms the bit sequence r₃, r₂, r₁, r₀, where r₀ is the LSB and r₃ is the MSB. When rᵢ is zero, i∈{0,1, . . . , 3}, PMI and RI reporting are not allowed to correspond to any precoder associated with v=i+1 layers.

The PMI value corresponds to the codebook indices i₁ and i₂ where

$$\text{?} = \{ \begin{matrix}\text{?} & υ = 1 \\ \text{?} & υ = 2 \\ \text{?} & υ = 3 \\ \text{?} & υ = 4\end{matrix}$$

$$\text{?} = \{ \begin{matrix}\text{?} & υ = 1 \\ \text{?} & υ = 2 \\ \text{?} & υ = 3 \\ \text{?} & υ = 4\end{matrix}$$

$$\text{?} \text{indicates text missing or illegible when filed}$$

The 2L antenna ports are selected by the index i_{1,1} as in clause 5.2.2.2.4 of 3GPP NR TS 38.214.

Parameters N₃, Mᵥ, Mᵢₙᵢₜᵢₐₗ (for N₃>19) and K₀ are defined as in clause 5.2.2.2.5 of 3GPP NR TS 38.214.

For layer l, l=1, . . . , v, the strongest coefficient i_{1,8,l}, the amplitude coefficient indicators l_{2,3,l} and i_{2,4,l}, the phase coefficient indicator i_{2,5,l} and the bitmap indicator i_{1,7,l} are defined and indicated as in clause 5.2.2.2.5, where the mapping from k_{l,p}⁽¹⁾ to the amplitude coefficient p_{l,p}⁽¹⁾ is given in Table 9 and the mapping from k_{l,i,f}⁽²⁾ to the amplitude coefficient p_{l,i,f}⁽²⁾ is given in Table 10.

The number of nonzero coefficients for layer l, Kₗ^{NZ}, and the total number of nonzero coefficients K^{NZ} are defined as in Clause 5.2.2.2.5 of 3GPP NR TS 38.214.

The amplitude coefficients pₗ⁽¹⁾ and pₗ⁽²⁾ (l=1, . . . , v) are represented as in clause 5.2.2.2.5.

The amplitude and phase coefficient indicators are reported as in clause 5.2.2.2.5 of 3GPP NR TS 38.214.

Codebook indicators i_{1,5} and i_{1,6,l} (l=1, . . . , v) are found as in clause 5.2.2.2.5 of 3GPP NR TS 38.214.

The codebooks for 1-4 layers are given in Table 15, where vₘ is a P_{CSI-RS}/2 -element column vector containing a value of 1 in element (m mod P_{CSI-RS}/2) and zeros elsewhere (where the first element is element 0), and the quantities φ_{l.i,f} and y_{t,l} are defined as in clause 5.2.2.2.5 of 3GPP NR TS 38.214.

TABLE 15
Codebook for 1-layer. 2-layer, 3-layer and 4-layer CSI
reporting using antenna ports 3000 to 2999+PCSI-RS

| | |
|---|---|
| υ = 1 | Wᵢ_{_{1,1}}_{,n}_{_{3,1}}_{,p}_{₁}_{⁽¹⁾}_{,p}_{₁}_{⁽²⁾}_{,i}_{_{2,5,1}}_{,t}⁽¹⁾ = Wᵢ_{_{1,1}},ₙ,_{_{3,1}},ₚ_{₁}_{⁽¹⁾},ₚ_{₁}_{⁽²⁾},ᵢ_{_{2,5,1}},ₜ¹ |
| υ = 2 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2}\end{matrix} ]$ |
| υ = 3 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \frac{1}{\sqrt{3}} [ \text{} \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} \\ {W}_{{i}_{1 , 1} , {n}_{3 , 3} , {p}_{3}^{( 1 )} , {p}_{3}^{( 2 )} , {i}_{2 , 5 , 3} , t}^{3} & \end{matrix} ]$ |
| υ = 4 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \frac{1}{2} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} \\ {W}_{{i}_{1 , 1} , {n}_{3 , 3} , {p}_{3}^{( 1 )} , {p}_{3}^{( 2 )} , {i}_{2 , 5 , 3} , t}^{3} & {W}_{{i}_{1 , 1} , {n}_{3 , 4} , {p}_{4}^{( 1 )} , {p}_{4}^{( 2 )} , {i}_{2 , 5 , 4} , t}^{4}\end{matrix} ]$ |

$Where {W}_{{i}_{1 , 1} , {n}_{3} , {p}_{l}^{( 1 )} , {p}_{l}^{( 2 )} , {i}_{2 , 5 , l} , t}^{l} = \frac{1}{\sqrt{{γ}_{t , l}}} [ \begin{matrix}{\sum }_{i = 0}^{L - 1} {v}_{{i}_{1 , 1} , d + i} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{i}_{1 , 1} , d + i} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$
and the mappings from i₁ to i_{1,1}, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾,
p₂⁽¹⁾, p₃⁽¹⁾ and p₄⁽¹⁾, p₁⁽²⁾, p₂⁽²⁾, p₃⁽²⁾ and p₄⁽²⁾ are as described above, including the ranges of the
constituent indices of i₁ and i₂.

For coefficients with k_{l,i,f}⁽³⁾=0, amplitude and phase are set to zero, i.e., p_{l,i,f}⁽²⁾=0 and φ_{l,i,f}=0.

Regarding UE Sounding Reference Signal (“SRS”) configuration, as discussed in 3GPP TS 38.214, the UE may be configured with one or more SRS resource sets as configured by the higher-layer parameter SRS-ResourceSet, wherein each SRS resource set is associated with K≥1 SRS resources (higher-layer parameter SRS-Resource), where the maximum value of K is indicated by UE capability. The SRS resource set applicability is configured by the higher-layer parameter usage in SRS-ResourceSet. The higher-layer parameter SRS-Resource configures some SRS parameters, including the SRS resource configuration identity (srs-Resourceld), the number of SRS ports (nrofSRS-Ports) with default value of one, and the time-domain behavior of SRS resource configuration (resourceType).

The UE may be configured by the higher-layer parameter resourceMapping in SRS-Resource with an SRS resource occupying Nₛ∈{1,2,4} adjacent symbols within the last 6 symbols of the slot, where all antenna ports of the SRS resources are mapped to each symbol of the resource.

For a UE configured with one or more SRS resource configuration(s), and when the higher-layer parameter resourceType in SRS-Resource is set to ‘aperiodic’:
The UE receives a configuration of SRS resource sets,
The UE receives a downlink DCI, a group common DCI, or an uplink DCI based command where a codepoint of the DCI may trigger one or more SRS resource set(s). For SRS in a resource set with usage set to ‘codebook’ or ‘antennaSwitching’, the minimal time interval between the last symbol of the PDCCH triggering the aperiodic SRS transmission and the first symbol of SRS resource is N₂. Otherwise, the minimal time interval between the last symbol of the PDCCH triggering the aperiodic SRS transmission and the first symbol of SRS resource is N₂+14. The minimal time interval in units of OFDM symbols is counted based on the minimum subcarrier spacing between the PDCCH and the aperiodic SRS.
If the UE is configured with the higher-layer parameter spatialRelationInfo containing the ID of a reference ‘ssb-Index’, the UE shall transmit the target SRS resource with the same spatial domain transmission filter used for the reception of the reference SS/PBCH block, if the higher-layer parameter spatialRelationInfo contains the ID of a reference ‘csi-RS-Index’, the UE shall transmit the target SRS resource with the same spatial domain transmission filter used for the reception of the reference periodic CSI-RS or of the reference semi-persistent CSI-RS, or of the latest reference aperiodic CSI-RS. If the higher-layer parameter spatialRelationInfo contains the ID of a reference ‘srs’, the UE shall transmit the target SRS resource with the same spatial domain transmission filter used for the transmission of the reference periodic SRS or of the reference semi-persistent SRS or of the reference aperiodic SRS.
[The update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise.]
When the UE is configured with the higher-layer parameter usage in SRS-ResourceSet set to ‘antennaSwitching’, the UE shall not expect to be configured with different spatial relations for SRS resources in the same SRS resource set.

For PUCCH and SRS on the same carrier, a UE shall not transmit SRS when semi-persistent and periodic SRS are configured in the same symbol(s) with PUCCH carrying only CSI report(s), or only L1-RSRP report(s), or only L1-SINR report(s). A UE shall not transmit SRS when semi-persistent or periodic SRS is configured or aperiodic SRS is triggered to be transmitted in the same symbol(s) with PUCCH carrying HARQ-ACK, link recovery request and/or SR. In the case that SRS is not transmitted due to overlap with PUCCH, only the SRS symbol(s) that overlap with PUCCH symbol(s) are dropped. PUCCH shall not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

When the UE is configured with the higher-layer parameter usage in SRS-ResourceSet set to ‘antennaSwitching’, and a guard period of Y symbols is configured, the UE shall use the same priority rules as defined above during the guard period as if SRS was configured.

Regarding UE sounding procedure for DL CSI acquisition, when the UE is configured with the higher-layer parameter usage in SRS-ResourceSet set as ‘antennaSwitching’, the UE may be configured with one configuration depending on the indicated UE capability supportedSRS-TxPortSwitch, which takes on the values {‘t1r2’, ‘t1r1-t1r2’, ‘t2r4’, ‘t1r4’, ‘t1r1-t1r2-t1r4’, ‘t1r4-t2r4’, ‘t1r1-t1r2-t2r2-t2r4’, ‘t1r1-t1r2-t2r2-t1r4-t2r4’, ‘t1r1’, ‘t2r2’, ‘t1r1-t2r2’, ‘t4r4’, ‘t1r1-t2r2-t4r4’}
For 1T2R, up to two SRS resource sets configured with a different value for the higher-layer parameter resourceType in SRS-Resource Set set, where each set has two SRS resources transmitted in different symbols, each SRS resource in a given set consisting of a single SRS port, and the SRS port of the second resource in the set is associated with a different UE antenna port than the SRS port of the first resource in the same set, or
For 2T4R, up to two SRS resource sets configured with a different value for the higher-layer parameter resourceType in SRS-Resource Set set, where each SRS resource set has two SRS resources transmitted in different symbols, each SRS resource in a given set consisting of two SRS ports, and the SRS port pair of the second resource is associated with a different UE antenna port pair than the SRS port pair of the first resource, or
For 1T4R, zero or one SRS resource set configured with higher-layer parameter resource Type in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port, and
For 1T4R, zero or two SRS resource sets each configured with higher-layer parameter resource Type in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources.
For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set are transmitted in the same slot. The guard period is in-between the SRS resources of the set. The value of Y is 2 when the OFDM sub-carrier spacing is 120 kHz, otherwise Y=1.

For 1T2R, 1T4R or 2T4R, the UE shall not expect to be configured or triggered with more than one SRS resource set with higher-layer parameter usage set as ‘antennaSwitching’ in the same slot. For 1T=1R, 2T=2R or 4T=4R, the UE shall not expect to be configured or triggered with more than one SRS resource set with higher-layer parameter usage set as ‘antennaSwitching’ in the same symbol.

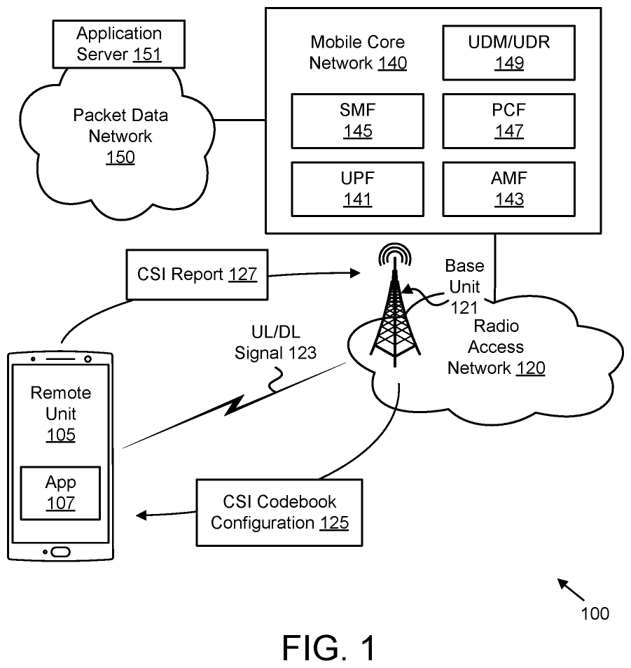

FIG. 1 depicts a wireless communication system 100 for parameter feedback for reciprocity-based Type-II codebook, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM).

In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 (or other communication peer) via a network connection with the mobile core network 140. For example, an application 107 in a remote unit 105 (e.g., web browser, media client, telephone and/or Voice-over-Internet-Protocol (“VoIP”) application) may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various embodiments, the remote unit 105 receives a CSI codebook configuration 125 from the base unit 121. As described in greater detail below, the configuration 125 may include multiple sets of parameter combinations.

Moreover, after receiving a set of CSI reference signals (“CSI-RS”), the remote unit 105 may select a subset of the multiple sets of parameter combinations (i.e., selects at least one of the parameter combinations) and indicates the selected parameter combination(s) in a CSI report 127 sent to the base unit 121.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Mobile Land Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

While FIG. 1 depicts components of a 5G RAN and a 5G core network, the described embodiments for parameter feedback for reciprocity-based Type-II codebook apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems supporting parameter feedback for reciprocity-based Type-II codebook.

In general, a UE is configured by higher-layers with one or more CSI-ReportConfig Reporting Settings, wherein each Reporting Setting may configure at least one CodebookConfig Codebook Configuration or one reportQuantity Reporting Quantity, or both, for CSI Reporting. Each Codebook Configuration represents at least one codebookType Codebook type, which includes indicators representing at least one or more of a CSI-RS Resource Indicator (“CRI”), a Synchronization-Signal Block Resource Indicator (“SSBRI”), a Rank Indicator (“RI”), a Precoding Matrix Indicator (“PMI”), a Channel Quality Indicator (“CQI”), a Layer Indicator (“L1”), a Layer-1 Reference Signal Received Power (“L1-RSRP”) and a Layer-1 Signal-to-Interference-plus-Noise Ratio (“L1-SINR”). Several embodiments are described below. According to a possible embodiment, one or more elements or features from one or more of the described embodiments may be combined.

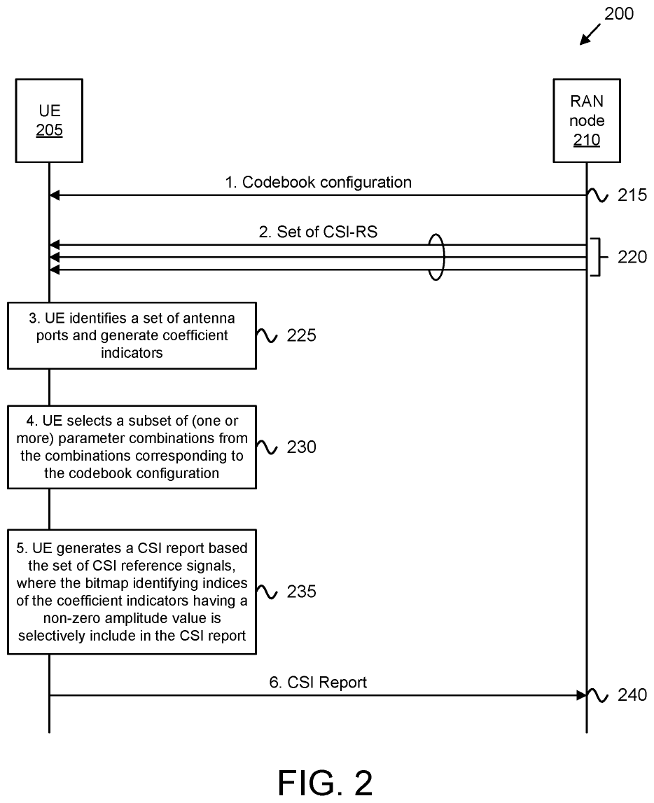

FIG. 2 depicts a first procedure 200 for parameter feedback for reciprocity-based Type-II codebook, according to embodiments of the disclosure. The first procedure involves a UE 205 and a RAN node 210, such as a gNB. The UE 205 may be one embodiment of the remote unit 105, while the RAN node 210 may be one embodiment of the base unit 121.

As depicted, at Step 1 the UE 205 receives, from the RAN node 210, a codebook configuration based on a port-selection codebook (see messaging 215). In some embodiments, the configuration also includes CSI configuration information.

At Step 2, the RAN node 210 transmits a set of CSI reference signals (see signaling 220). Note that the set of CSI reference signals (i.e., CSI-RS) may be beamformed reference signals (“RSs”). In some embodiments, the beamforming may be based on a set of sounding reference signals sent by the UE 205 to the RAN node 210 (SRS transmission not depicted in FIG. 2).

At Step 3, the UE 205 identifies a set of antenna ports based on the set of CSI reference signals and generates at least one coefficient amplitude indicator and one coefficient phase indicator for each antenna port in the identified set of antenna ports (see block 225).

At Step 4, the UE 205 generating a set of coefficient indicators corresponding to the identified set of ports, where a subset of the coefficient indicators is assigned a non-zero amplitude value (see block 230). Here, the port-selection codebook may comprise a first bitmap that identifies the indices (i.e., locations) of the subset of the coefficient indicators having the non-zero amplitude value.

At Step 5, the UE 205 generates a CSI report based the set of CSI reference signals, where the CSI report contains codebook parameters for one or more layers and further containing an indication of a size (i.e., total number or quantity) of the subset of the coefficient indicators (see block 235). Importantly, the first bitmap is selectively included in the CSI report based on a size of the subset of the coefficient indicators having the non-zero amplitude value. In some embodiments, the inclusion of the first bitmap depends on at least one of a configuration from the RAN, and a subset of the codebook parameters in the CSI report.

At Step 6, the UE 205 transmits to the RAN node 210 a CSI report indicating the selected parameter combination to the RAN node 210 (see messaging 240).

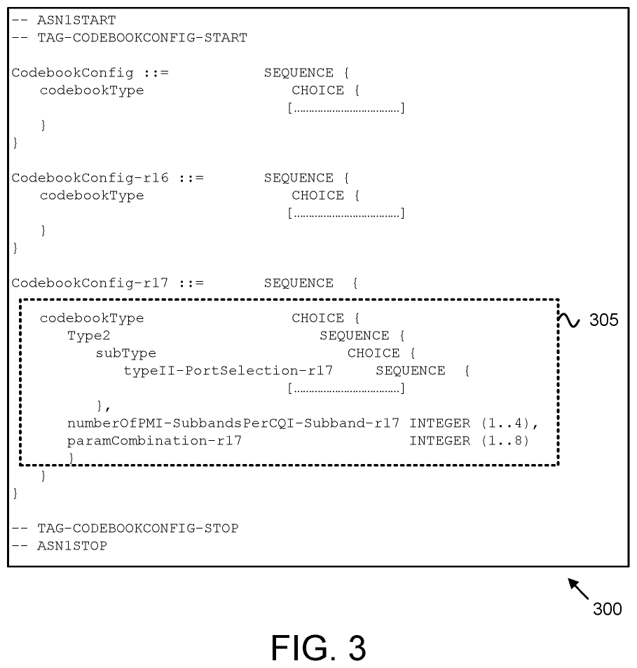

Regarding indication of reciprocity-based codebook, the network may configure a UE with a reciprocity-based codebook as part of CSI feedback reporting, via one or more of the indications discussed below with reference to FIGS. 3-5.

FIG. 3 depicts an example of Abstract Syntax Notation One (“ASN.1”) code for configuring the UE with a reciprocity-based codebook 300, according to a first embodiment. Here, the RAN node 210 may send the codebook configuration 300 to the UE 205. The original ASN.1 code for this IE can be found in Clause 6.3.2 of 3GPP TS 38.331.

According to the first embodiment, the network (i.e., RAN) introduces one or more additional values to the higher-layer parameter CodebookType (see block 305). In one embodiment, the parameter CodebookType may be part of one or more Codebook Configuration Information Elements (“IE”) that were introduced in Rel-15 and Rel-16, i.e., CodebookConfig, or CodebookConfig-r16, respectively. In another embodiment, the parameter CodebookType may be part of a new Codebook Configuration IE introduced in Release 17 (“Rel-17”) and/or Release 18 (“Rel-18”), i.e., CodebookConfig-r17 or CodebookConfig-r18.

All the Codebook Configuration IEs are part of the CSI-ReportConfig Reporting Setting IE. Examples of the additional values of the CodebookType parameter are ‘typeII-PortSelection-r17’, or ‘typeII-Reciprocity’.

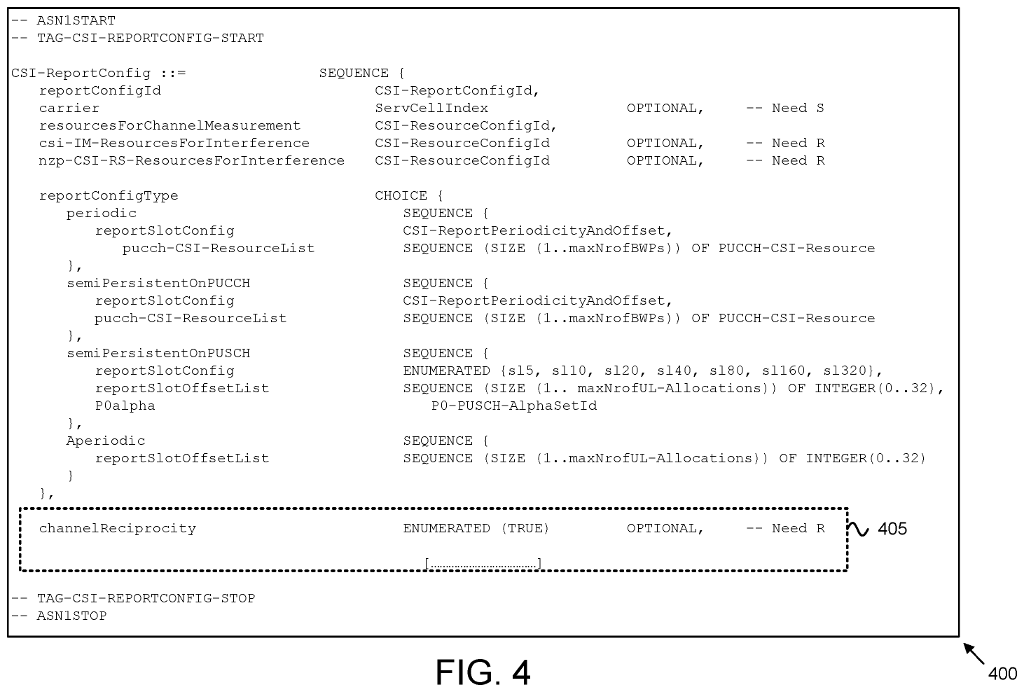

FIG. 4 depicts an example of ASN.1 code for configuring the UE with a reciprocity-based codebook 400, according to a second embodiment. Here, the RAN node 210 may send the codebook configuration 400 to the UE 205. The original ASN.1 code for this IE can be found in Clause 6.3.2 of 3GPP TS 38.331.

According to the second alternative, the network introduces an additional higher-layer parameter, e.g., channelReciprocity, within the CSI-ReportConfig Reporting Setting IE that configures the UE with CSI feedback reporting based on channel reciprocity (see block 405). The Channel Reciprocity parameter may appear in different sub-elements of the Reporting Setting IE.

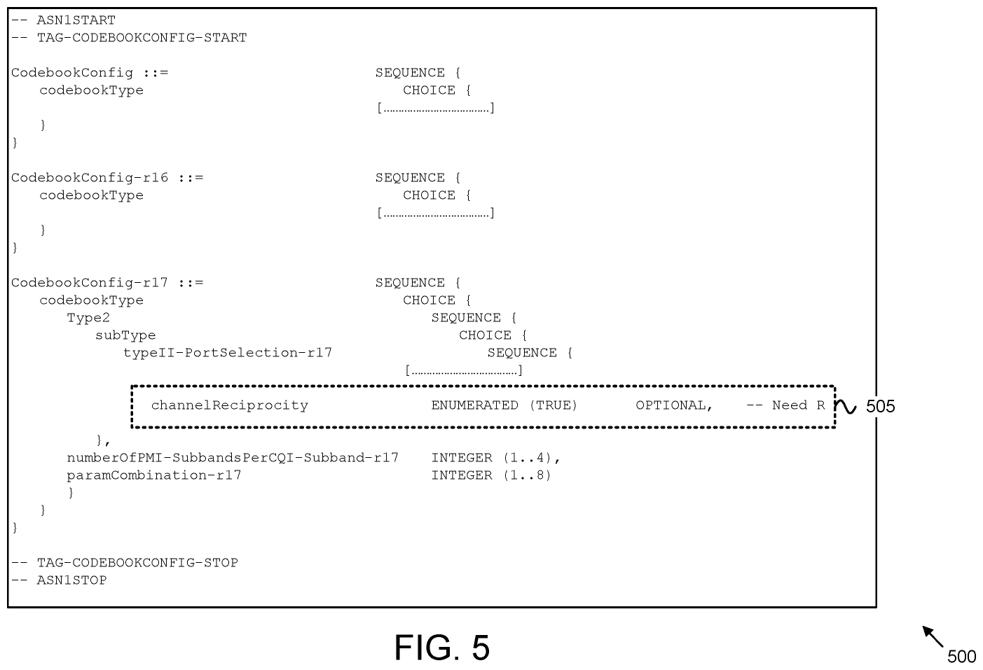

FIG. 5 depicts an example of ASN.1 code for configuring the UE with a reciprocity-based codebook 500, according to a third embodiment. Here, the RAN node 210 may send the codebook configuration 500 to the UE 205. The original ASN.1 code for this IE can be found in Clause 6.3.2 of 3GPP TS 38.331.

According to the third alternative, the network introduces an additional higher-layer parameter, e.g., channelReciprocity, within the Codebook Configuration CodebookConfig IE. In one embodiment, the new parameter is under the Codebook Configuration IE, e.g., CodebookConfig, CodebookConfig-r16. In another embodiment, the new parameter is under a new configuration such as CodebookConfig-r17 (see block 505). In yet another embodiment, the new parameter is a sub-parameter within the higher-layer parameter codebookType, whenever the Codebook Type is set to ‘typeII-PortSelection,’ ‘typeII-PortSelection-r16’ or another Type-II Port Selection Codebook, e.g., ‘typeII-PortSelection-r17.’

Due to the exploitation of the FDD reciprocity of the channel, a RAN node may transmit beamformed CSI-RSs, where the CSI-RS beamforming is based on the UL channel estimated via SRS transmission. The beamforming can then flatten the channel in the frequency domain, i.e., a fewer number of significant channel taps, i.e., taps with relatively large power, are observed at the UE, compared with non-beamformed CSI-RS transmission. Such beamforming may result in a fewer number of coefficients, corresponding to fewer FD basis indices, being fed back in the CSI report.

In the following, different codebook designs are described that exploit channel reciprocity to reduce the overall CSI feedback overhead. Several embodiments are described below. According to a possible embodiment, one or more elements or features from one or more of the described embodiments may be combined.

Regarding the Frequency Domain (“FD”) basis selection indication, for the port-selection codebook under discussion, the FD basis indices of the codebook correspond to columns of a frequency-domain basis transformation. In one example the frequency-domain basis transformation is a Discrete Fourier transformation, as follows

$${y}_{t , l} = [ \begin{matrix}{y}_{t , l}^{( 0 )} & {y}_{t , l}^{( 1 )} & … & {y}_{t , l}^{( {M}_{υ} - 1 )}\end{matrix} ]$$

where t={0,1, . . . , N₃−1} represents the index of the PMI sub-band out of N3 PMI sub-bands, and 1 is the layer index associated with the precoding matrix, l={1, . . . , v}, such that

$${y}_{t , l}^{( f )} = {e}^{j \frac{2 π {tn}_{3 , l}^{( f )}}{{N}_{3}}}$$

for f=0,1, . . . , Mᵥ−1, where f is the index of the (transformed) frequency domain basis, and Mv represents the size of the frequency domain basis for a given rank v. Here,

$${M}_{υ} = ⌈ {p}_{υ} \frac{{N}_{3}}{R} ⌉$$

vectors, [y_{0,l}^{(f)}, y_{1,l}^{(f)}, . . . , y_{N}_{₃}^{(f)}_{-1,l}]^{T}, f=0,1, . . . , Mᵥ−1, are identified by Mᵢₙᵢₜᵢₐₗ (possibly for N₃>19 or any N3) and n_{3,l} (l=1, . . . , v) where

$${M}_{initial} ∈ \{ - {N}_{w} + 1 , - {N}_{w} + 2 , … , 0 \}$$

$${n}_{3 , l} = [ {n}_{3 , l}^{( 0 )} , … , {n}_{3 , l}^{( {M}_{υ} - 1 )} ]$$

$${n}_{3 , l}^{( f )} ∈ \{ 0 , 1 , … , {N}_{3} - 1 \}$$

which are indicated by means of the indices i_{1,5} (possibly for N₃>19 or any N₃) and i_{1,6,l} (for Mᵥ>1 and l=1, . . . , v), where

$${i}_{1 , 5} ∈ \{ 0 , 1 , … , {N}_{w} - 1 \}$$

$${i}_{1 , 6 , l} ∈ \{ 0 , 1 , … , ( \begin{matrix}{N}_{w} - 1 \\ {M}_{υ} - 1\end{matrix} ) - 1 \}$$

Note that N_{w} represents a set of contiguous FD basis indices (window), where N_{w}≥Mᵥ.

Regarding the value of window size N_{w}:

In a first embodiment, N_{w} is a network configured constant value, e.g., N_{w}=4. Note that in this embodiment the window size is fixed and constant.

In a second embodiment, N_{w} is a network configured value that depends on at least one of a configured parameter R (the number of PMI sub-bands per CQI sub-band), and Mᵥ, e.g., N_{w}=RMᵥ. Note that in this embodiment the window size is fixed and parameter based.

In a third embodiment, N_{w} is a UE-reported value as part of a CSI Report, e.g., N_{W}∈{Mᵥ, Mᵥ+1, . . . , χ−1}, where χX>Mᵥ. Note that in this embodiment the window size is UE reported.

Regarding the reporting window location Mᵢₙᵢₜᵢₐₗ:

In a first embodiment, Mᵢₙᵢₜᵢₐₗ is reported by the UE in terms of i_{1,5}, wherein i_{1,5} occupies ┌log₂ N_{w}┐ bits. Note that is this embodiment the window location is UE reported.

In a second embodiment, Mᵢₙᵢₜᵢₐₗ is configured by the network and indicated to the UE in terms of a higher-layer parameter that occupies ┌log₂ N_{w}┐ bits, i.e., i_{1,5} is not reported by the UE. Note that in this embodiment the window location is network configured.

In a third embodiment, Mᵢₙᵢₜᵢₐₗ is fixed, i_{1,5} is not reported by the UE. In one example,

$${M}_{initital} = ⌈ \frac{- {N}_{w}}{2} ⌉ .$$

Note that in this embodiment, the window location is fixed (i.e., by a rule).

Regarding the reporting of FD basis indices:

In a first embodiment, i_{1,5} (if reported) and i_{1,6,l} corresponding to the FD basis window location and the selected FD basis indices for each layer 1, are not reported when v<δ. In one example, i_{1,5} and i_{1,6,l} are not reported if v=1, i.e., total number of layers is one.

Regarding bitmap reporting, the bitmap whose nonzero bits identify which linear-combination coefficients are reported by the UE is indicated by a parameter i_{1,7,l}, where

$${i}_{1 , 7 , l} = [ {k}_{l , 0}^{( 3 )} … {k}_{l , {M}_{υ} - 1}^{( 3 )} ]$$

$${k}_{l , f}^{( 3 )} = [ {k}_{l , 0 , f}^{( 3 )} … {k}_{l , 2 , L - 1 , f}^{( 3 )} ]$$

$${k}_{l , i , f}^{( 3 )} ∈ \{ 0 , 1 \}$$

The maximum number of linear-combination coefficients reported by the UE may be parametrized by a parameter K₀, wherein K₀ may depend on at least one of L, M₁, Mᵥ, R, β, wherein β is a higher-layer parameter configured by the network to indicate a fraction of the reported coefficients. In one example, K₀=┌β2LM₁┐. Here, L represents the number of spatial beams per polarization of the precoder for a given layer, where i-0, . . . ,2L−1, polarization. for l=1, . . . , v. In one example, Kₗ^{NZ}=Σᵢ₌₀^{2L-1}Σ_{f=0}^{M}^{ᵥ}⁻¹k_{l,i,f}⁽³⁾≤K₀ is the number of nonzero coefficients for layer l=1, . . . , v and K^{NZ}=Σᵢ₌₁^{v}Kₗ^{NZ}≤2K₀ is the total number of nonzero coefficients.

According to embodiments of a first solution for bitmap reporting, the UE may report a unified bitmap within the CSI report.

In a first embodiment, the bitmap is not reported, i.e., i_{1,7,l} is not reported, whenever the configured number of FD basis indices falls below a certain threshold Mv<λ. In one example, i_{1,7,l} is not reported whenever Mv=1. Note that the bitmap not reported when only 1 FD basis index is configured.

In a second embodiment, the bitmap is not reported, i.e., i_{1,7,l} is not reported,

whenever the configured parameter corresponding to the fraction of reported coefficients, β jumps above a certain threshold β≥μ. In one example, i_{1,7,l} is not reported whenever μ=3/4 or μ=1. Note that the bitmap is not reported when all coefficients are configured to be reported.

In a third embodiment, the bitmap includes 2L entries for each layer, such that i_{1,7,l}=[k_{l,0}⁽³⁾ . . . k_{l,2L-1}⁽³⁾], and k_{l,i}⁽³⁾∈{0,1}. Note that a bitmap of size 2L is reported, which selects the coefficient reported from one of two taps. In one example, when Mᵥ=2, setting k_{l,i}⁽³⁾=0 indicates that a coefficient corresponding to a first of Mᵥ=2 FD basis indices (f=0 where f∈{0, Mᵥ−1}={0,1}) is reported for layer l, spatial beam index i, whereas setting k_{l,i}⁽³⁾=1 indicates that a coefficient corresponding to a second of Mᵥ=2 FD basis indices (f=1 where f∈{0, Mᵥ−1} ={0,1}) is reported for layer l, spatial beam index i.

In a fourth embodiment, the bitmap includes L entries for each layer only, such that i_{1,7,l}=[k_{l,0}⁽³⁾ . . . k_{l,L-1}⁽³⁾], and k_{l,i}⁽³⁾∈{0,1}. In one example, if Mᵥ=2, setting k_{l,i}⁽³⁾=0 indicates that two coefficients corresponding to a first of Mᵥ=2 FD basis indices (f=0 where f∈{0, Mᵥ−1}={0,1}) are reported for layer l, spatial beam indices i, i+L, whereas setting k_{l,i}⁽³⁾=1 indicates that two coefficient corresponding to a second of Mᵥ=2 FD basis indices (f=1 where f∈{0, Mᵥ−1}={0,1}) are reported for layer l, spatial beam indices i, i+L. Note that a bitmap of size L is reported, which selects the coefficient reported from one of two taps.

In a fifth embodiment, the bitmap i_{1,7,l} is reported in the form of a combinatorial parameter based on a combinatorial function C(x,y), as defined in Table 11, Clause 5.2.2.2.5, of 3GPP NR TS 38.214. Note that a combinatorial parameter is reported instead of a bitmap.

According to embodiments of a second solution for bitmap reporting, the UE may report two bitmaps within the CSI report.

In a first embodiment, two bitmaps i_{1,7,1,l} and i_{1,7,2,l} are reported per layer, such that

$${i}_{1 , 7 , 1 , l} = [ {k}_{1 , l , 0}^{( 3 )} … {k}_{1 , l , 2 L - 1}^{( 3 )} ]$$

$${i}_{1 , 7 , 2 , l} = [ {k}_{2 , l , 0}^{( 3 )} … {k}_{2 , l , {M}_{v} - 1}^{( 3 )} ]$$

$${k}_{1 , l , i}^{( 3 )} ∈ \{ 0 , 1 \}$$

$${k}_{2 , l , f}^{( 3 )} ∈ \{ 0 , 1 \}$$

wherein for a first of the two bitmaps, i_{1,7,1,l}, setting k_{1,l,i}⁽³⁾=0 indicates that all coefficients corresponding to a layer l and a spatial beam index i are not reported, and wherein for a second of the two bitmaps, i_{1,7,2,l}, setting k_{2,l,f}⁽³⁾=0 indicates that all coefficients corresponding to a layer l and an FD basis index f are not reported. Note that in this first embodiment, two bitmaps for 2L beams and M taps, respectively, are reported. A zero-value means all corresponding coefficients are not reported.

In a second embodiment, two bitmaps i_{1,7,1,l} and i_{1,7,2,l} are reported per layer, such that

$${i}_{1 , 7 , 1 , l} = [ {k}_{1 , l , 0}^{( 3 )} … {k}_{1 , l , L - 1}^{( 3 )} ]$$

$${i}_{1 , 7 , 2 , l} = [ {k}_{2 , l , 0}^{( 3 )} … {k}_{2 , l , {M}_{v} - 1}^{( 3 )} ]$$

$${k}_{1 , l , i}^{( 3 )} ∈ \{ 0 , 1 \}$$

$${k}_{2 , l , f}^{( 3 )} ∈ \{ 0 , 1 \}$$

wherein for a first of the two bitmaps, i_{1,7,1,l}, setting k_{1,l,i}⁽³⁾=0 indicates that all coefficients corresponding to a layer l and spatial beam indices i, i+L are not reported, and wherein for a second of the two bitmaps, i_{1,7,2,l}, setting k_{2,l,f}⁽³⁾=0 indicates that all coefficients corresponding to a layer l and an FD basis index f are not reported. Note that in this second embodiment, two bitmaps for L beams and M taps respectively. A zero-value means all corresponding coefficients are not reported.

In a third embodiment, two parameters i_{1,7,1,l} and i_{1,7,2,l} are reported per layer, such that

$${i}_{1 , 7 , 1 , l} = [ {k}_{l , 0}^{( 3 )} … {k}_{l , 2 L - 1}^{( 3 )} ]$$

$${i}_{1 , 7 , 2 , l} ∈ \{ 0 , 1 , … , {M}_{v} - 1$$

$${k}_{l , i , f}^{( 3 )} ∈ \{ 0 , 1 \}$$

wherein for the (bitmap) parameter, i_{1,7,1,l}, setting k_{l,i}⁽³⁾=0 indicates that all coefficients corresponding to a layer l and a spatial beam index i are not reported, and wherein setting the parameter i_{1,7,2,l} to m*∈{0,1, . . . , Mᵥ−1} indicates that all coefficients corresponding to a layer l and an FD basis index f=m* are not reported. The number of bits needed to report i_{1,7,2,l} may be determined using the ceiling function ┌log₂ Mᵥ┐ bits. Note that in this embodiment there is a bitmap of size 2L and a parameter with bitwidth log₂M which selects an unreported tap.

In a fourth embodiment, two parameters i_{1,7,1,l} and i_{1,7,2,l} are reported per layer, such that

$${i}_{1 , 7 , 1 , l} = [ {k}_{l , 0}^{( 3 )} … {k}_{l , 2 L - 1}^{( 3 )} ]$$

$${i}_{1 , 7 , 2 , l} ∈ \{ 0 , 1 , … , {M}_{v} - 1 \}$$

$${k}_{l , i}^{( 3 )} ∈ \{ 0 , 1 \}$$

wherein for the (bitmap) parameter, i_{1,7,1,l}, setting k_{l,i}⁽³⁾=0 indicates that all coefficients corresponding to a layer l and a spatial beam index i are not reported, and wherein setting the parameter i_{1,7,2,l} to m*∈{0,1, . . . , Mᵥ−1} indicates that all coefficients corresponding to a layer l and an FD basis index f=m* are reported, with the exception of coefficients with k_{l,i}⁽³⁾=0. The number of bits needed to report i_{1,7,2,l} may be determined using the ceiling function ┌log₂ Mᵥ┐ bits. Note that in this embodiment there is a bitmap of size 2L and a parameter with bitwidth log₂M which selects a reported tap (except for zeroed beams).

In a fifth embodiment, two parameters i_{1,7,1,l} and i_{1,7,2,l} are reported per layer, such that

$${i}_{1 , 7 , 1 , l} = [ {k}_{l , 0}^{( 3 )} … {k}_{l , L - 1}^{( 3 )} ]$$

$${i}_{1 , 7 , 2 , l} ∈ \{ 0 , 1 , … , {M}_{v} - 1 \}$$

$${k}_{l , i}^{( 3 )} ∈ \{ 0 , 1 \}$$

wherein for the (bitmap) parameter, i_{1,7,1,l}, setting k_{l,i}⁽³⁾=0 indicates that all coefficients corresponding to a layer l and spatial beam indices i, i+L are not reported, and wherein setting the parameter i_{1,7,2,l} to m*∈{0,1, . . . , Mᵥ−1} indicates that all coefficients corresponding to a layer l and an FD basis index f=m* are not reported. The number of bits needed to report i_{1,7,2,l} may be determined using the ceiling function ┌log₂ Mᵥ┐ bits. Note that in this embodiment there is a bitmap of size L and a parameter with bitwidth log₂M which selects an unreported tap.

In a sixth embodiment, two parameters i_{1,7,1,l} and i_{1,7,2,l} are reported per layer, such that

$${i}_{1 , 7 , 1 , l} = [ {k}_{l , 0}^{( 3 )} … {k}_{l , L - 1}^{( 3 )} ]$$

$${i}_{1 , 7 , 2 , l} ∈ \{ 0 , 1 , … , {M}_{v} - 1 \}$$

$${k}_{l , i}^{( 3 )} ∈ \{ 0 , 1 \}$$

wherein for the (bitmap) parameter, i_{1,7,1,l}, setting k_{;,i}⁽³⁾=0 indicates that all coefficients corresponding to a layer l and spatial beam indices i, i+L are not reported, and wherein setting the parameter i_{1,7,2,l} to m*∈{0,1, . . . , Mᵥ−1} indicates that all coefficients corresponding to a layer l and an FD basis index f=m* are reported, with the exception of coefficients with k_{l,i}⁽³⁾=0. The number of bits needed to report i_{1,7,2,l} may be determined using the ceiling function ┌log₂ Mᵥ┐ bits. Note that in this embodiment there is a bitmap of size L and a parameter with bitwidth log₂M which selects a reported tap (except for zeroed beams).

Regarding Antenna Panel/Port, Quasi-collocation, Transmission Configuration Indicator (“TCI”) state, and Spatial Relation, in some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels.” In one implementation, the device may support UL transmission from one beam within a panel: with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (“QCL”) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type.

The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Spatial Rx parameters may include one or more of: angle of arrival (“AoA”), Dominant AoA, average AoA, angular spread, Power Angular Spectrum (“PAS”) of AoA, average angle of departure (“AoD”), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mm Wave, FR2 and beyond), where essentially the UE may not be able to perform omni-directional transmission, i.e., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same Receive (“RX”) beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of Demodulation Reference Signal (“DM-RS”) ports of the target transmission during a transmission occasion) and a source reference signal(s) (e.g., Synchronization Signal Block (“SSB”) and/or CSI-RS and/or SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

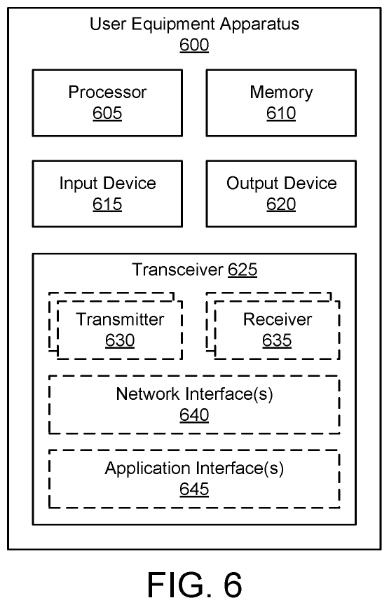

FIG. 6 depicts a user equipment apparatus 600 that may be used for parameter feedback for reciprocity-based Type-II codebook, according to embodiments of the disclosure. In various embodiments, the user equipment apparatus 600 is used to implement one or more of the solutions described above. The user equipment apparatus 600 may be one embodiment of the remote unit 105 and/or the UE 205, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, the transceiver 625 receives, from a RAN, a codebook configuration for a port-selection codebook and receives a set of CSI reference signals. The processor 605 identifies a set of ports based on the set of CSI reference signals and generates a set of (i.e., one or more) coefficient indicators corresponding to the port-selection codebook, where a subset of the coefficient indicators is assigned a non-zero amplitude value, where the port-selection codebook comprises a first bitmap that identifies (i.e., indices/locations of) the subset of the coefficient indicators having the non-zero amplitude value. Note that the port-selection codebook has two dimensions: spatial dimension (corresponding to antenna ports) and frequency dimension (corresponding to frequency domain basis indices).

The processor 605 generate a CSI report based the set of CSI reference signals, where the CSI report comprises codebook parameters for one or more layers and further contains an indication of a size (i.e., total number) of the subset of the coefficient indicators, where the first bitmap is selectively included in the CSI report based on a size of the subset of the coefficient indicators having the non-zero amplitude value. In certain embodiments, the inclusion of the first bitmap depends on at least one of a configuration from the RAN, and a subset of the codebook parameters in the CSI report. Via the transceiver 625, the processor 605 transmits the CSI report to the RAN.

In some embodiments, the first bitmap is not included in the CSI report (i.e., reported) when all coefficients corresponding to a maximum number of configured coefficients have non-zero amplitude value. In some embodiments, the first bitmap is not included in the CSI report (i.e., not reported) when a configured fraction of non-zero coefficients is greater than or equal to a configured threshold value. In one embodiment, the configured threshold value is equal to one.

In some embodiments, the first bitmap corresponds to coefficients associated with a selected set of FD basis indices. In certain embodiments, the first bitmap is not included in the CSI report (i.e., not reported) when a configured number of selected FD basis indices is less than a threshold amount. In one embodiment, the configured number of selected FD basis indices is equal to one.

In some embodiments, the CSI report contains separate bitmaps that indicate indices of non-zero coefficients reported for each layer corresponding to the one or more layers. In some embodiments, a size of the first bitmap is equal to a number of the identified set of ports. In certain embodiments, a configured number of selected FD basis indices is equal to two.

In certain embodiments, for each bit in the first bitmap, a zero value of the bit corresponds to the non-zero coefficient corresponding to the first FD basis index being non-zero, and a one value of the bit corresponds to the non-zero coefficient corresponding to the second FD basis index being non-zero. In certain embodiments, comprising identifying, for each layer corresponding to the one or more layers, a second bitmap of size equal to the configured number of selected FD basis indices, where the CSI report includes the second bitmap. In further embodiments, the second bitmap identifies whether coefficients corresponding to a selected FD basis index are assigned a zero amplitude value.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to parameter feedback for reciprocity-based Type-II codebook and/or mobile operation. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

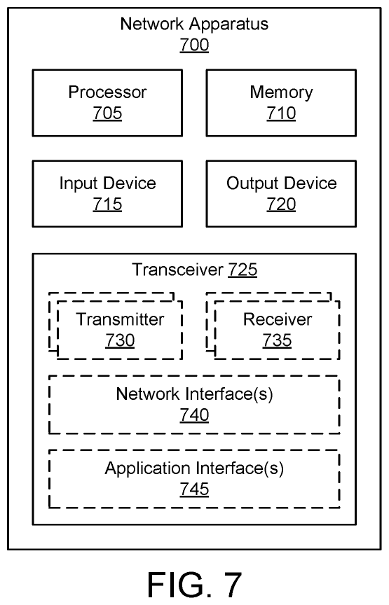

FIG. 7 depicts a network apparatus 700 that may be used for parameter feedback for reciprocity-based Type-II codebook, according to embodiments of the disclosure. In one embodiment, network apparatus 700 may be one implementation of device in a mobile communication network, such as the base unit 121 and/or the RAN node 210, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 controls the transceiver 725 to send to a UE a codebook configuration for a port-selection codebook and to transmit a set of CSI reference signals. The transceiver 725 further receives a CSI report from the UE, where the CSI report comprises codebook parameters for one or more layers and further contains an indication of a size (i.e., total number) of a subset of coefficient indicators having the non-zero amplitude value. In certain embodiments, the CSI report may include a first bitmap that identifies (i.e., indices/locations of) the subset of the coefficient indicators having the non-zero amplitude value. The UE is configured to only include the first bitmap in the CSI report when certain conditions are met.

In some embodiments, the first bitmap is not included in the CSI report (i.e., reported) when all coefficients corresponding to a maximum number of configured coefficients have non-zero amplitude value. In some embodiments, the first bitmap is not included in the CSI report (i.e., not reported) when a configured fraction of non-zero coefficients is greater than or equal to a configured threshold value. In one embodiment, the configured threshold value is equal to one.

In some embodiments, the first bitmap corresponds to coefficients associated with a selected set of FD basis indices. In certain embodiments, the first bitmap is not included in the CSI report (i.e., not reported) when a configured number of selected FD basis indices is less than a threshold amount. In one embodiment, the configured number of selected FD basis indices is equal to one.

In some embodiments, the CSI report contains separate bitmaps that indicate indices of non-zero coefficients reported for each layer corresponding to the one or more layers. In some embodiments, a size of the first bitmap is equal to a number of the identified set of ports. In certain embodiments, a configured number of selected FD basis indices is equal to two.

In certain embodiments, for each bit in the first bitmap, a zero value of the bit corresponds to the non-zero coefficient corresponding to the first FD basis index being non-zero, and a one value of the bit corresponds to the non-zero coefficient corresponding to the second FD basis index being non-zero. In certain embodiments, comprising identifying, for each layer corresponding to the one or more layers, a second bitmap of size equal to the configured number of selected FD basis indices, where the CSI report includes the second bitmap. In further embodiments, the second bitmap identifies whether coefficients corresponding to a selected FD basis index are assigned a zero amplitude value.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to parameter feedback for reciprocity-based Type-II codebook. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

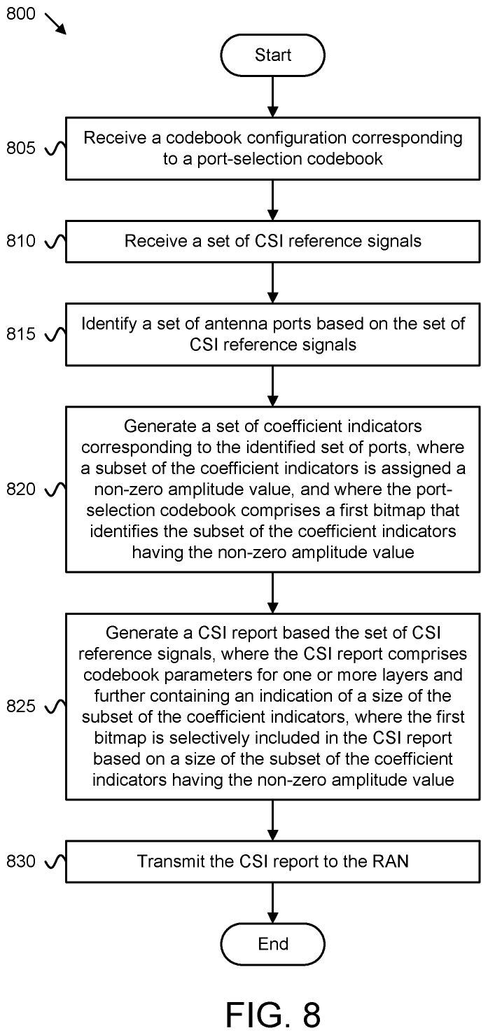

FIG. 8 depicts one embodiment of a method 800 for parameter feedback for reciprocity-based Type-II codebook, according to embodiments of the disclosure. In various embodiments, the method 800 is performed by a UE device, such as the remote unit 105, the UE 205, and/or the user equipment apparatus 600, described above as described above. In some embodiments, the method 800 is performed by a processor, such as a microcontroller, a microprocessor, a CPU, a GPU, an auxiliary processing unit, a FPGA, or the like.

The method 800 begins and receives 805, from a RAN, a codebook configuration corresponding to a port-selection codebook. The method 800 includes receiving 810 a set of CSI reference signals. The method 800 includes identifying 815 a set of ports based on the set of CSI reference signals. The method 800 includes generating 820 a set of (i.e., one or more) coefficient indicators corresponding to the identified set of ports, where a subset of the coefficient indicators is assigned a non-zero amplitude value, and where the port-selection codebook comprises a first bitmap that identifies the subset of the coefficient indicators having the non-zero amplitude value.

The method 800 includes generating 825 a CSI report based the set of CSI reference signals, wherein the CSI report comprises codebook parameters for one or more layers and further containing an indication of a size (i.e., total number) of the subset of the coefficient indicators, where the first bitmap is selectively included in the CSI report based on a size of the subset of the coefficient indicators having the non-zero amplitude value. The method 800 includes transmitting 830 the CSI report to the RAN. The method 800 ends.

Disclosed herein is a first apparatus for parameter feedback for reciprocity-based Type-II codebook, according to embodiments of the disclosure. The first apparatus may be implemented by a UE device, such as the remote unit 105, the UE 205, and/or the user equipment apparatus 600, described above. The first apparatus includes a processor coupled to a transceiver, the processor and the transceiver configured to cause the first apparatus to: A) receive, from a RAN, a codebook configuration for a port-selection codebook: B) receive a set of CSI reference signals: C) identify a set of ports based on the set of CSI reference signals: D) generate a set of (i.e., one or more) coefficient indicators corresponding to the port-selection codebook, where a subset of the coefficient indicators is assigned a non-zero amplitude value, where the port-selection codebook comprises a first bitmap that identifies (i.e., indices/locations of) the subset of the coefficient indicators having the non-zero amplitude value: E) generate a CSI report based the set of CSI reference signals, where the CSI report comprises codebook parameters for one or more layers and further containing an indication of a size (i.e., total number) of the subset of the coefficient indicators, where the first bitmap is selectively included in the CSI report based on a size of the subset of the coefficient indicators having the non-zero amplitude value: and F) transmit the CSI report to the RAN.

In some embodiments, the first bitmap is not included in the CSI report (i.e., reported) when all coefficients corresponding to a maximum number of configured coefficients have non-zero amplitude value. In some embodiments, the first bitmap is not included in the CSI report (i.e., not reported) when a configured fraction of non-zero coefficients is greater than or equal to a configured threshold value. In one embodiment, the configured threshold value is equal to one.

In some embodiments, the first bitmap corresponds to coefficients associated with a selected set of FD basis indices. In certain embodiments, the first bitmap is not included in the CSI report (i.e., not reported) when a configured number of selected FD basis indices is less than a threshold amount. In one embodiment, the configured number of selected FD basis indices is equal to one.

In some embodiments, the CSI report contains separate bitmaps that indicate indices of non-zero coefficients reported for each layer corresponding to the one or more layers. In some embodiments, a size of the first bitmap is equal to a number of the identified set of ports. In certain embodiments, a configured number of selected FD basis indices is equal to two.

In certain embodiments, for each bit in the first bitmap, a zero value of the bit corresponds to the non-zero coefficient corresponding to the first FD basis index being non-zero, and a one value of the bit corresponds to the non-zero coefficient corresponding to the second FD basis index being non-zero. In certain embodiments, comprising identifying, for each layer corresponding to the one or more layers, a second bitmap of size equal to the configured number of selected FD basis indices, where the CSI report includes the second bitmap. In further embodiments, the second bitmap identifies whether coefficients corresponding to a selected FD basis index are assigned a zero amplitude value.

Disclosed herein is a first method for parameter feedback for reciprocity-based Type-II codebook, according to embodiments of the disclosure. The first method may be performed by a UE device entity, such as the remote unit 105, the UE 205, and/or the user equipment apparatus 600, described above. The first method includes receiving, from a RAN, a codebook configuration corresponding to a port-selection codebook and receiving a set of CSI reference signals. The first method includes identifying a set of ports based on the set of CSI reference signals and generating a set of (i.e., one or more) coefficient indicators corresponding to the identified set of ports, wherein a subset of the coefficient indicators is assigned a non-zero amplitude value, where the port-selection codebook comprises a first bitmap that identifies (i.e., indices and/or locations of) the subset of the coefficient indicators having the non-zero amplitude value. The first method includes generating a CSI report based the set of CSI reference signals and transmitting the CSI report to the RAN, where the CSI report comprises codebook parameters for one or more layers and further containing an indication of a size (i.e., total number) of the subset of the coefficient indicators, where the first bitmap is selectively included in the CSI report based on a size of the subset of the coefficient indicators having the non-zero amplitude value.

In some embodiments, the first bitmap is not included in the CSI report (i.e., reported) when all coefficients corresponding to a maximum number of configured coefficients have non-zero amplitude value. In some embodiments, the first bitmap is not included in the CSI report (i.e., not reported) when a configured fraction of non-zero coefficients is greater than or equal to a configured threshold value. In one embodiment, the configured threshold value is equal to one.

In some embodiments, the first bitmap corresponds to coefficients associated with a selected set of FD basis indices. In certain embodiments, the first bitmap is not included in the CSI report (i.e., not reported) when a configured number of selected FD basis indices is less than a threshold amount. In one embodiment, the configured number of selected FD basis indices is equal to one.

In some embodiments, the CSI report contains separate bitmaps that indicate indices of non-zero coefficients reported for each layer corresponding to the one or more layers. In some embodiments, a size of the first bitmap is equal to a number of the identified set of ports. In certain embodiments, a configured number of selected FD basis indices is equal to two.

In certain embodiments, for each bit in the first bitmap, a zero value of the bit corresponds to the non-zero coefficient corresponding to the first FD basis index being non-zero, and a one value of the bit corresponds to the non-zero coefficient corresponding to the second FD basis index being non-zero. In certain embodiments, comprising identifying, for each layer corresponding to the one or more layers, a second bitmap of size equal to the configured number of selected FD basis indices, where the CSI report includes the second bitmap. In further embodiments, the second bitmap identifies whether coefficients corresponding to a selected FD basis index are assigned a zero amplitude value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a User Equipment device (“UE”) for generating a CSI report, wherein the report consists of information corresponding to one or more layers, the method comprising:
receiving, from a Radio Access Network (“RAN”), a codebook configuration corresponding to a port-selection codebook:
receiving a set of Channel State Information (“CSI”) reference signals:
identifying a set of ports based on the set of CSI reference signals;
generating a set of coefficient indicators corresponding to the identified set of ports, wherein a subset of the coefficient indicators is assigned a non-zero amplitude value,
wherein the port-selection codebook comprises a first bitmap that identifies the subset of the coefficient indicators having the non-zero amplitude value:
generating a CSI report based the set of CSI reference signals, wherein the CSI report comprises codebook parameters for one or more layers and further containing an indication of a size of the subset of the coefficient indicators,
wherein the first bitmap is selectively included in the CSI report based on a size of the subset of the coefficient indicators having the non-zero amplitude value; and
transmitting the CSI report to the RAN.

2. The method of claim 1, wherein the first bitmap is not included in the CSI report when all coefficients corresponding to a maximum number of configured coefficients have non-zero amplitude value.

3. The method of claim 1, wherein the first bitmap is not included in the CSI report when a configured fraction of non-zero coefficients is greater than or equal to a configured threshold value.

4. The method of claim 3, wherein the configured threshold value is equal to one.

5. The method of claim 1, wherein the first bitmap corresponds to coefficients associated with a selected set of frequency domain (“FD”) basis indices.

6. The method of claim 5, wherein the first bitmap is not included in the CSI report when a configured number of selected FD basis indices is less than a threshold amount.

7. The method of claim 6, wherein the configured number of selected FD basis indices is equal to one.

8. The method of claim 1, wherein the CSI report contains separate bitmaps that indicate indices of non-zero coefficients reported for each layer corresponding to the one or more layers.

9. The method of claim 1, wherein a size of the first bitmap is equal to a number of the identified set of ports.

10. The method of claim 9, wherein a configured number of selected frequency domain (“FD”) basis indices is equal to two.

11. The method of claim 10, wherein, for each bit in the first bitmap, a zero value of the bit corresponds to the non-zero coefficient corresponding to the first FD basis index being non-zero, and a one value of the bit corresponds to the non-zero coefficient corresponding to the second FD basis index being non-zero.

12. The method of claim 10, further comprising identifying, for each layer corresponding to the one or more layers, a second bitmap of size equal to the configured number of selected FD basis indices, wherein the CSI report includes the second bitmap.

13. The method of claim 12, wherein the second bitmap identifies whether coefficients corresponding to a selected FD basis index are assigned a zero amplitude value.

14. A User Equipment (“UE”) apparatus comprising:
a transceiver; and
a processor coupled to the transceiver, the processor and the transceiver configured to cause the apparatus to:
receive, from a Radio Access Network (“RAN”), a codebook configuration for a port-selection codebook:
receive a set of Channel State Information (“CSI”) reference signals:
identify a set of ports based on the set of CSI reference signals:
generate a set of coefficient indicators corresponding to the port-selection codebook, wherein a subset of the coefficient indicators is assigned a non-zero amplitude value,
wherein the port-selection codebook comprises a first bitmap that identifies the subset of the coefficient indicators having the non-zero amplitude value;
generate a CSI report based the set of CSI reference signals, wherein the CSI report comprises codebook parameters for one or more layers and further containing an indication of a size of the subset of the coefficient indicators,
wherein the first bitmap is selectively included in the CSI report based on a size of the subset of the coefficient indicators having the non-zero amplitude value; and
transmit the CSI report to the RAN.

15. The apparatus of claim 14, wherein the first bitmap is not included in the CSI report when all coefficients corresponding to a maximum number of configured coefficients have non-zero amplitude value.
